(19) United States
(12) Patent Application Publication
(10) Pub. No.: US 2012/0263485 A1
(43) Pub. Date: Oct. 18, 2012

(54) IMAGE FORMING DEVICE

(75) Inventors: Masashi OBA, Shiojiri (JP); Akihiro GOMI, Fujimi-machi (JP); Kunihiro KAWADA, Shiojiri (JP); Yuki OGUCHI, Okaya (JP); Mitsukazu KUROSE, Shiojiri (JP); Ken IKUMA, Suwa (JP)

(73) Assignee: SEIKO EPSON CORPORATION, Tokyo (JP)

(21) Appl. No.: 13/443,447

(22) Filed: Apr. 10, 2012

(30) Foreign Application Priority Data
Apr. 12, 2011 (JP) 2011-087934
Apr. 12, 2011 (JP) 2011-087935
Apr. 15, 2011 (JP) 2011-090760

(51) Int. Cl. G03G 15/10

(52) U.S. Cl. 399/57

(57) ABSTRACT

In order to improve the precision of liquid level computation in an accommodating part for accommodating a developer, the image forming device of the invention includes an accommodating part for accommodating a developer including a toner and a carrier, a developer container into which is supplied developer from the accommodating part, an electrostatic capacity detector for detecting electrostatic capacity, the electrostatic capacity detector having a first electrode provided to the accommodating part, a second electrode provided to the accommodating part, and a counter electrode opposite the first electrode and the second electrode, interposed by the developer; and a controller for stopping supply of developer from the accommodating part to the developer container based on a first electrostatic capacity detected by the first electrode and the counter electrode of the electrostatic capacity detector, and a second electrostatic capacity detected by the second electrode and the counter electrode.

### CROSS-REFERENCE TO RELATED APPLICATIONS

This application incorporates, by way of reference, the entire content of the specification, drawings, and abstract contained in Japanese Patent Application No. 2011-87934 submitted on Apr. 12, 2011, Japanese Patent Application No. 2011-87935 submitted on Apr. 12, 2011, and Japanese Patent Application No. 2011-90760 submitted on Apr. 15, 2011.

### BACKGROUND

1. Technical Field

The present invention relates to a development device for developing a latent image that has been formed on a photosensitive body and an image forming device for further transferring the image that has been developed by the developing device using a developer composed of toner and carrier onto a recording medium and for fusing and fixing the transferred image.

2. Background Technology

Various wet-format image forming devices have been offered in which a latent image is developed using a high-viscosity toner that is composed of a toner that includes a solid component that is dispersed in a liquid solvent. Developers that are used in this type of wet-format image forming device are produced by suspending a solid content (toner particles) in a high-viscosity organic solvent (carrier liquid) that has electrical insulating properties and is composed of silicone oil, mineral oil, food oil, or the like. The toner particles are extremely fine, with a particle diameter of about 1 μm. As a result of using this type of fine toner particle, high-quality images can be produced relative to dry-format image forming devices that employ powdered toner particles with particle diameters of about 7 μm.

With developing parts that are used in image forming devices that employ this type of developer, in order to ascertain the remaining amount of developer, various technologies have been offered for detecting the liquid level of the developer in the container part that contains the developer.

For example, in patent document 1 (JP (Kokai) 2001-194208), a water storage level detector is disclosed that includes a substrate, a first electrode plate that is supported on the substrate with a prescribed spacing provided, and a second electrode plate that extends from the substrate to a higher level than the first electrode plate and has an opening part that corresponds to the outer circumferential surface of the first electrode plate. The detector also includes an electrode part that is provided at a prescribed detection level on one side of the container that stores the solution to be detected and a water storage level detection part that detects the presence or absence of the solution at the detection position based on the change in electrostatic potential that is measured using the first electrode plate and the second electrode plate.

### SUMMARY

In the past, a structure was used that had a water storage level measurement device and an electrostatic capacity-type storage water level detector on an outside part of the container that stores the liquid, and this storage water level detector has low sensitivity, because it is disposed outside the container. There was thus the problem that the detector can only determine whether liquid was present or absent.

Due to problems of the type described above, it has not been possible to determine a suitable amount of replenishment agent, and thus replenishment has been carried out with an inappropriate amount of replenishment agent, which has resulted in lengthy time periods to achieve the target concentration or liquid level, large fluctuations in developer concentration, and degradation of image quality.

The image forming device according to an aspect of the invention resolves the above problems by including: a latent image support on which a latent image is formed;

an exposure part for exposing the latent image support to light and forming the latent image on the latent image support; a toner concentration adjustment part for adjusting the toner concentration of the developer, the toner concentration adjustment part having an accommodating part for accommodating a developer including a toner and a carrier, and an electrostatic capacity detector for detecting electrostatic capacity, the electrostatic capacity detector having a first electrode provided to the accommodating part, a second electrode provided to the accommodating part, and a counter electrode opposite the first electrode and the second electrode interposed by the developer; a developer supply part for supplying, to the accommodating part, developer having a higher toner concentration than the toner concentration of the developer adjusted by the toner concentration adjustment part; a carrier supply part for supplying a carrier to the accommodating part; a developing part having a developer container into which is supplied developer whose toner concentration has been adjusted by the toner concentration adjustment part, and a developer support for supporting the developer accommodated in the developer container and developing the latent image on the latent image support; and a controller for controlling an amount of developer supplied by the developer supply part and an amount of carrier supplied by the carrier supply part, based on a first electrostatic capacity detected by the first electrode and the counter electrode of the electrostatic capacity detector and a second electrostatic capacity detected by the second electrode and the counter electrode.

In addition, with the image forming device of the invention, the controller stops supply of the developer from the accommodating part to the developer container based on the first electrostatic capacity and the second electrostatic capacity.

In addition, the image forming device of the invention a computation part for computing the liquid level of the developer produced in the accommodating part based on the first electrostatic capacity and the second electrostatic capacity.

With the image forming device of the invention described above, supply of developer to the developer container is controlled based on the first electrostatic capacity detected by the first electrode and the second electrostatic capacity that serves as a reference value and is detected by the second electrode. When a decrease in the liquid level is detected by comparing the electrostatic capacity measured by these two electrodes, transfer of liquid to the developer container is stopped, or replenishment of high-concentration developer and carrier liquid is carried out, thereby suppressing a decrease in the liquid level and allowing second electrode to be continually maintained in the developer. Because the dielectric constant of the developer is detected and a correction is carried out during liquid level computation in accordance with the electrostatic capacity that is measured by the second electrode in the developer, the precision of the liquid level computation can be dramatically improved, without being influenced by changes in developer concentration or temperature.

In addition, the image forming device of the invention includes: a latent image support on which a latent image is formed; an exposure part for exposing the latent image support to light and forming the latent image on the latent image support; a developing part that has a developing container for accommodating a developer including a toner and a carrier, and a developer support for supporting the developer accommodated in the developer container and developing the latent image; and a developer reservoir having an accommodating part for accommodating a developer supplied to the developing part, and an electrostatic capacity detector for detecting electrostatic capacity, the electrostatic capacity detector having a first electrode provided in the accommodating part, a second electrode provided to the accommodating part opposite the first electrode and interposed by the developer, and a third electrode provided to the accommodating part opposite the first electrode and interposed by the developer.

In addition, with the image forming device of the invention, the third electrode is disposed vertically below the second electrode.

In addition, the image forming device of the present invention includes a developer supply tube for supplying liquid developer from the accommodating part to the developing container, the developer supply tube having an inlet within the accommodating part; and the third electrode is disposed vertically below the inlet of the liquid developer supply tube.

In addition, the image forming device of the invention includes the electrostatic capacity detector having a fourth electrode corresponding to the first electrode, which is provided to the accommodating part, via the developer.

In addition, with the image forming device of the invention, the accommodating part further includes a discharge opening for discharging developer, and the fourth electrode is disposed vertically above the discharge opening of the accommodating part.

With the image forming device of the invention, the electrostatic capacity that is obtained from the first electrode and the third electrode is used as a reference value in order to determine the liquid level of the developer from the electrostatic capacity that is obtained from the first electrode and the second electrode, and the liquid level can thus be determined while taking into account the change in the dielectric constant of the developer due to temperature or concentration. In accordance with the image forming device of the invention of this type, by ascertaining the liquid level of the accommodating part, it is possible to replenish an appropriate amount so that the developer reaches the target concentration, thereby preventing degradation of image quality.

In addition, the image forming device of the invention includes: a latent image support on which a latent image is formed; an exposure part for exposing the latent image support to light and forming the latent image on the latent image support; a developer reservoir for storing developer, the developer reservoir having an accommodating part for accommodating a developer including a toner and a carrier, and an electrostatic capacity detector for detecting electrostatic capacity, the electrostatic capacity detector having a first electrode provided to the accommodating part, and a second electrode provided to the accommodating part; a developing part having a developer container into which is supplied developer accommodated in the accommodating part of the developer reservoir, and a developer support for supporting the developer accommodated in the developer container and developing the latent image that has been formed on the latent image support; and a computation part for computing a liquid level of the developer in the accommodating part based on a first electrostatic capacity detected between the first electrode and the counter electrode and a second electrostatic capacity detected between the second electrode and the counter electrode.

In addition, with the image forming device of the invention, the electrostatic capacity detector has a counter electrode that is opposite the first electrode and the second electrode.

In addition, with the image forming device of the invention, the second electrode is disposed vertically below the first electrode and opposite the counter electrode, interposed by the developer.

In addition, with the image forming device of the invention, the first electrode is opposite the counter electrode and interposed by the developer, and the second electrode is disposed vertically above the first electrode and opposite the counter electrode, without being interposed by the developer.

In addition, the image forming device of the invention further a cable for conductively connecting the first electrode and a capacity measurement circuit, wherein the computation part computes the electrostatic capacity of the cable using the first electrostatic capacity detected between the first electrode and the counter electrode.

With the image forming device of the invention, the second electrostatic capacity that is detected by the second electrode is used as a reference value in order to determine the liquid level of the developer from the electrostatic capacity that is obtained from the first electrode, and the liquid level can thus be determined while taking into account the change in the dielectric constant of the developer due to temperature or concentration. In accordance with the image forming device of the invention of this type, by ascertaining the liquid level of the accommodating part, it is possible to replenish an appropriate amount so that the developer reaches the target concentration, thereby preventing degradation of image quality.

### BRIEF DESCRIPTION OF THE DRAWINGS

Referring now to the attached drawings which form a part of this original disclosure:

FIG. 1 is a diagram showing the essential constituent elements that constitute the image forming device pertaining to an embodiment of the invention;

FIG. 2 is a sectional view showing the essential constituent elements of the image forming part and the developing device;

FIG. 3 is a sectional view showing a schematic configuration of the concentration adjustment tank in the developing device;

FIG. 4 is a diagram illustrating the measurement principle of the electrostatic capacity type liquid level sensor;

FIG. 5 is a diagram showing the relationship between electrostatic capacity and liquid level determined from the measurement principle of the electrostatic capacity type liquid level sensor;

FIG. 6 is a schematic diagram of the relationship between temperature and the dielectric constant ∈_{dev} of the developer;

FIG. 7 is a schematic diagram of the relationship between concentration and the dielectric constant ∈_{dev} of the developer;

FIG. 8 is a diagram illustrating the relationship between electrostatic capacity and the liquid level;

FIG. 9 is a diagram showing a block configuration related to liquid level control of the developer in the concentration adjustment tank;

FIG. 10 is a diagram showing a flow chart related to liquid level control of the developer in the concentration adjustment tank;

FIG. 11 shows a block configuration related to liquid level control in the concentration adjustment tank of the developing device pertaining to the second embodiment;

FIG. 12 is a diagram showing a flow chart related to liquid level control in the concentration adjustment tank of the developing device pertaining to the second embodiment;

FIG. 13 is a diagram illustrating the relationship between electrostatic capacity and liquid level in the third embodiment;

FIG. 14 is a sectional view showing a schematic configuration of the concentration adjustment tank in the developing device;

FIG. 15 is a diagram illustrating the measurement principle of the electrostatic capacity type liquid level sensor;

FIG. 16 is a diagram illustrating the relationship between electrostatic capacity and liquid level determined from the measurement principle of the electrostatic capacity type liquid level sensor;

FIG. 17 is a schematic diagram of the relationship between temperature and dielectric constant ∈_{dev} of the developer;

FIG. 18 is a schematic diagram of the relationship between temperature and dielectric constant ∈_{dev} of the developer;

FIG. 19 is a diagram that shows a block configuration related to calculation of the liquid level of the developer in the concentration adjustment tank;

FIG. 20 is a sectional view showing the schematic configuration of the concentration adjustment tank in the developing device pertaining to the fifth embodiment;

FIG. 21 is a sectional view showing the schematic configuration of the concentration adjustment tank of the developing device;

FIG. 22 is a diagram illustrating the measurement principle of the electrostatic capacity type liquid level sensor;

FIG. 23 is a diagram showing the relationship between electrostatic capacity and liquid level determined from the measurement principle of the electrostatic capacity type liquid level sensor;

FIG. 24 is a schematic diagram showing the relationship between temperature and the dielectric constant ∈_{dev} of the developer;

FIG. 25 is a schematic diagram of the relationship between temperature and the dielectric constant ∈_{dev} of the developer;

FIG. 26 is a diagram that shows a block configuration related to calculation of the liquid level of the developer in the concentration adjustment tank;

FIG. 27 is a flow chart for calculating the liquid level of the developer in the concentration adjustment tank;

FIG. 28 is a diagram illustrating the electrostatic capacity type liquid level sensor 810Y of the developing device pertaining to the seventh embodiment;

FIG. 29 is a diagram illustrating the electrostatic capacity type liquid level sensor 810Y of the developing device pertaining to the seventh embodiment;

FIG. 30 is a diagram illustrating the electrostatic capacity type liquid level sensor 810Y of the developing device pertaining to the seventh embodiment;

FIG. 31 is a diagram showing the block configuration related to calculation of the liquid level of the developer in the concentration adjustment tank 400Y pertaining to the ninth embodiment; and

FIG. 32 is a diagram showing a flow chart related to calculating the liquid level of the developer in the concentration adjustment tank pertaining to the ninth embodiment.

### DETAILED DESCRIPTION OF EXEMPLARY EMBODIMENTS

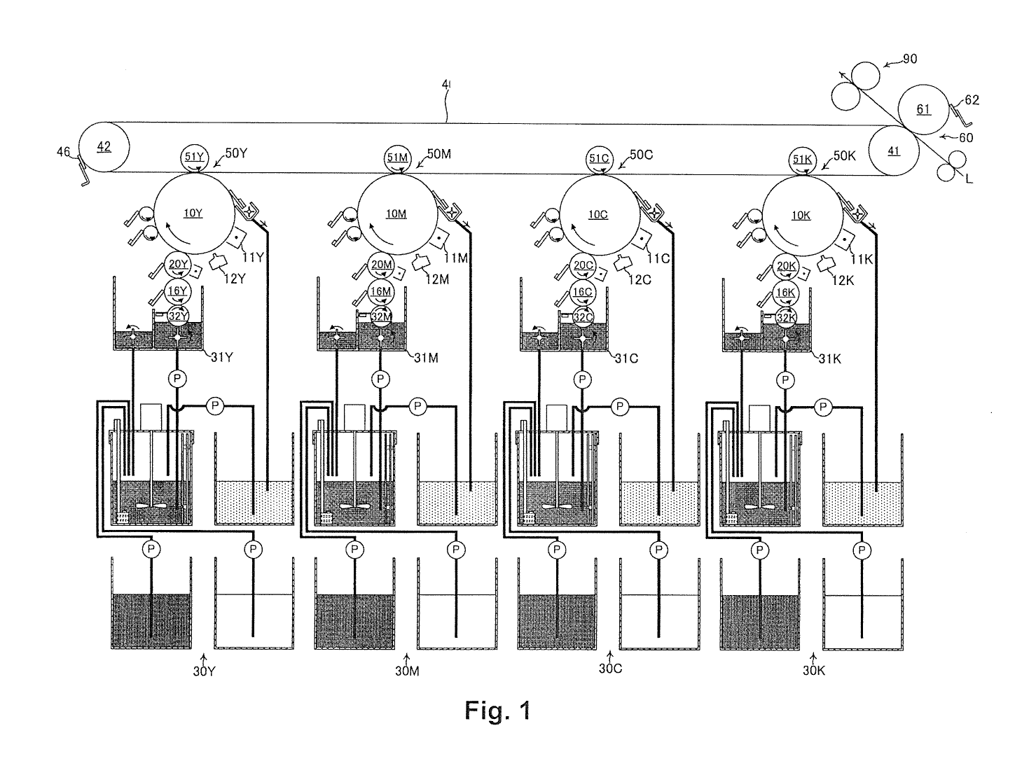

Embodiments of the invention are described below with reference to the drawings. FIG. 1 is a diagram showing the essential constituent elements that constitute the image forming device pertaining to an embodiment. The development devices 30Y, 30M, 30C, 30K for each color in the image forming part that have been disposed in the middle part of the image forming device are disposed in a lower part of the image forming device, and the transfer belt 40 and the secondary transfer part (secondary transfer unit) 60 are disposed in an upper part of the image forming device.

The image forming part has photosensitive bodies 10Y, 10M, 10C, 10K, corona dischargers 11Y, 11M, 11C, 11K, exposure units 12Y, 12M, 12C, 12K, and the like. The photosensitive bodies 10Y, 10M, 10C, 10K are temporarily charged by the corona dischargers 11Y, 11M, 11C, 11K, and the respective exposure heads that are carried on exposure units 12Y, 12M, 12C, 12K are driven based on an image signal that has been input, thereby forming electrostatic latent images on the charged photosensitive bodies 10Y, 10M, 10C, 10K.

The developing devices 30Y, 30M, 30C, 30K in general, have developing rolls 20Y, 20M, 20C, 20K, developer containers (reservoirs) 31Y, 31M, 31C, 31K, and anilox rolls 32Y, 32M, 32C, 32K which are application rolls for applying the developer of each color from the developer containers 31Y, 31M, 31C, 31K onto the developing rolls 20Y, 20M, 20C, 20K. The electrostatic latent images that are formed on the photosensitive bodies 10Y, 10M, 10C, 10K are developed by the developer of each color.

The transfer belt 40 is an endless belt that is suspended between a drive roller 41 and a tension roller 42 and is driven to rotate by a drive roller 41 while being made to impinge upon the photosensitive bodies 10Y, 10M, 10C, 10K by the primary transfer parts 50Y, 50M, 50C, 50K. At the primary transfer parts 50Y, 50M, 50C, 50K, the primary transfer rolls 51Y, 51M, 51C, 51K are disposed opposite the photosensitive bodies 10Y, 10M, 10C, 10K with the transfer belt 40 sandwiched between, and the transfer location is the location of impingement with the photosensitive bodies 10Y, 10M, 10C, 10K. As a result, a toner image for each color that is present on the developed photosensitive bodies 10Y, 10M, 10C, 10K is transferred by sequential superposition on the transfer belt 40, thereby forming a full color toner image.

With the secondary transfer unit 60, the secondary transfer roll 61 is disposed opposite the belt driver roller 41, with the transfer belt 40 sandwiched between, and a cleaning device including a secondary transfer roll cleaning blade 62 is also provided. In the transfer location where the secondary transfer roll 61 is disposed, the monochromic toner image or the full color toner image that has been formed on the transfer belt 40 is transferred to a recording medium such as a paper, film, cloth, or the like, which has been transported by the sheet material transport pathway L.

In addition, a fixing unit 90 is disposed downstream from the sheet material transport pathway L, and the monochromic toner image or full color toner image that has been transferred to the recording medium such as paper is fused and fixed on the recording medium such as paper.

In addition, the tension roller 42 suspends the transfer belt 40 along with the belt driver roller 41, and a cleaning device including a transfer belt cleaning blade 46 is provided so as to impinge at the spot where the transfer belt 40 is suspended on the tension roller 42.

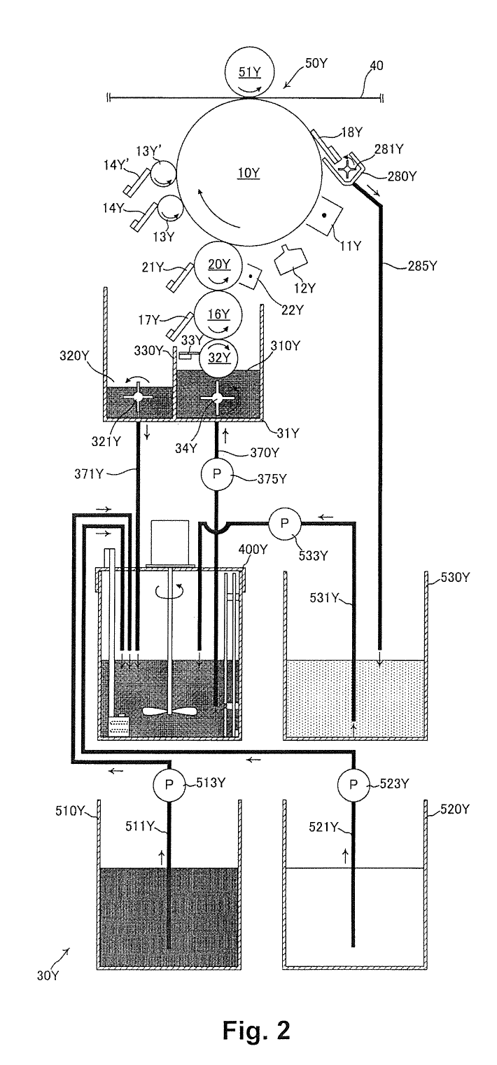

The image forming part and developing device of the image forming device pertaining to an embodiment of the invention will be described below. FIG. 2 is a sectional view showing the essential constituent elements of the image forming part and the developing device. The configuration of the image forming part and the developing device for each color is the same, and thus a description will be presented based on the image forming part and developing device for yellow (Y).

In the image forming part are disposed, along the direction of rotation of the outer circumference of the photosensitive body 10Y, a photosensitive body cleaning blade 18Y, a corona discharger 11Y, an exposure unit 12Y, a developing roll 20 for the developing device 30Y, a photosensitive body squeeze roll 13Y, and a photosensitive body squeeze roll 13Y′. In addition, a cleaning device composed of photosensitive body squeeze roll cleaning blades 14Y, 14Y′ is disposed in an attached configuration on the photosensitive body squeeze rolls 13Y, 13Y′.

On the outer circumference of the developing roll 20Y in the developing device 30Y are disposed a cleaning blade 21Y, an elastic roll 16Y, and a toner compression corona generator 22Y. The anilox roll 32Y impinges upon the elastic roll 16Y, and a regulating blade 33Y that controls the amount of developer that is supplied to the developing roll 20Y impinges upon the anilox roll 32.

An elastic roll cleaning blade 17Y that scrapes off the excess developer remaining on the elastic roll 16Y that has not been supplied to the developing roll 20Y impinges upon the elastic roll 16Y.

The developer container 31Y is partitioned into two spaces by a partitioning part 330Y, a supply reservoir part 310Y and a recovery reservoir part 320Y, where an auger 34Y for developer supply is housed in the supply reservoir part 310Y, and a recovery auger 321Y for developer recovery is housed in the recovery reservoir part 320Y.

In addition, a first transfer roll 51Y of the first transfer part is disposed in a position that is opposite the photosensitive body 10Y along the transfer belt 40.

The photosensitive body 10Y is wider than the developing roll 20Y and is a photosensitive body drum that is composed of a cylindrical member having a photosensitive layer that is formed on the outer circumferential surface. The drum rotates, for example, in the clockwise direction as shown in FIG. 2. The photosensitive layer of the photosensitive body 10Y is constituted by an organic photosensitive body, an amorphous silicone photosensitive body, or the like. The corona discharger 11Y is disposed upstream from the nip part between the photosensitive body 10Y and the developing roll 20Y in the rotation direction of the photosensitive body 10Y. A voltage is applied from a power source device that is not shown in the drawings, and the photosensitive body 10Y is subjected to corona charging. The exposure unit 12Y forms a latent image on the photosensitive body 10Y by carrying out irradiating the photosensitive body 10Y that has been charged by the corona charger 11Y at a location that is downstream from the corona discharger 11Y in the direction of rotation of the photosensitive body 10Y.

Considering the image forming process from its beginning to end, those configurations of rolls or the like that are disposed towards the former are defined as being upstream from those configurations of rolls or the like that are disposed towards the latter.

In the supply reservoir part 310Y of the exposure device 30Y, developer is reserved in a condition in which toner is dispersed in the carrier at a rough weight ratio of about 25%. On the other hand, the recovery reservoir part 320Y of the exposure device 30Y also has a recovery auger 321Y that recovers developer that has not been supplied to the anilox roll 32Y, developer that has been scraped off by the photosensitive body squeeze roll cleaning blades 14Y, 14Y′, developer that has been scraped off from the developing roll 20Y by the cleaning blade 21Y, developer that has been scarped off from the elastic roll 16Y by the elastic roll cleaning blade 17Y, and the like.

In addition, a toner compression corona generator 22Y that has a compacting action is provided in the exposure device 30Y. This toner compression corona generator 22Y applies a bias voltage to the developer on the developing roll 20Y in order to improve the developing efficiency by placing the toner in a compressed state in the developer.

The exposure device 30Y has a developing roll 20Y for supporting the developer, an elastic roll 16Y whereby developer is supplied to the developing roll 20Y, an anilox roll 32Y that is an application roll that applies the developer to the elastic roll 16Y, a regulation blade 33Y that regulates the amount of developer that is applied to the developing roll 20Y, an auger 34Y for supplying developer to the anilox roll 32Y by stirring and transporting it, a toner compression corona generator 22Y that places the developer that is carried on the developing roll 20Y in a compacted state, and a developing roll cleaning blade 21Y that cleans the developing roll 20Y. A “compacted state” means that the toner content in the developer is placed in a compacted state on the side of the surface of the developing roll 20Y.

Rather than being a low-viscosity volatile developer having a low concentration (about 1 to 3 wt %) that uses Isopar™ (Exxon) that has been commonly used in the past, the developer that is contained in the developer container 31Y is a non-volatile developer having a high concentration, a high viscosity, and low volatility at normal temperatures.

Specifically, the developer of the invention is a developer that has a toner solids concentration of about 25% and a high viscosity (about 30 to 300 mPa·s under a shear rate of 1000 (1/s) at 25° C. produced using a HAAKE Rheostress RS600 device).

The agent is produced by using a liquid solvent such as organic solvent, silicone oil, mineral oil, food oil, or the like, and adding and dispersing solids with an average particle diameter of 1 μm which are produced by dispersing a coloring agent such as a pigment in a thermoplastic resin.

To present a more detailed description, the developer in the invention is produced by dispersing at least a binder resin in a liquid silicone oil having a viscosity of 0.5 to 1000 mPa·s (25° C.) and a viscosity expressed by a viscoelasticity of 30 mPa·s to 300 mPa·s (25° C.) measured at a shear rate of 1000 (s⁻¹) and 25° C. using a HAAKE RheoStress RS600 device.

Liquid silicone oil is a low-volatility carrier and is selected from a group consisting of straight-chain liquid silicones, cyclic liquid silicones, branching liquid silicones, and combinations thereof.

Examples of liquid silicone oils that can be cited are DC200 Fluid (20 cSt), DC 200 Fluid (100 cST), DC 200 Fluid (50 cSt), and DC 345 Fluid, manufactured by Dow Corning (USA).

Examples of pigments include organic coloring agents such as nigrosine, phthalocyanine blue, and quinacridone, and inorganic coloring agents such as carbon black and iron oxide. Examples of binder resins include epoxy resins, polyacrylates, polyesters, and copolymers thereof, alkyd resins, rosins, rosin esters, modified epoxy resins, polyvinyl acetate resins, styrene-butadiene resins, cyclized rubbers, ethylene-vinyl acetate copolymers, and polyethylenes.

The pigment and binder resin can be directly dispersed in the liquid silicone oil, but the pigment and binder resin are preferably melt-kneaded to produce a pigment that is coated with binder resin.

Examples of resin-coated pigments that can be cited are epoxy resin-coated Araldite 6084 (C.I. Pigment Blue 15:3 manufactured by Ciba Geigy), Tintacarb 435 (C.I. Pigment Black 7, manufactured by Cabot Corp.), Irgalite Rubine KB4N(C.I. Pigment Red 57, manufactured by Ciba Geigy), and Monolite Yellow (C.I. Pigment Yellow 1, manufactured by ICI Australia). These coated pigments can be mixed at the appropriate ratio and melt-kneaded and ground to produce a master batch, which is then used in the production of the developer described below. In addition, during melt-kneading of the epoxy resin-coated pigment, alkylated polyvinylpyrrolidone can be added and allowed to react with the epoxy resin, thereby producing a master batch in which the coating resin is modified epoxy resin.

The dispersant is a polysiloxane having functional groups selected from vinyl groups, carboxylic acid groups, hydroxyl groups, and amine groups, and the polysiloxane can be selected from a linear polysiloxane, a cyclic polysiloxane, a branched polysiloxane, or combinations thereof. Examples that can be cited include Elastsil M4640A (polysiloxane polymer having vinyl functional groups, manufactured by Wacker Chemical) and Finish WR1101 (polysiloxane polymer having amine functional groups, manufactured by Wacker Chemical), which are compounds having viscosities of 90,000 mPa·s or less. Polysiloxanes having functional groups bind or adsorb to the surfaces of the colored resin particles via the functional groups, thereby making the colored particles compatible with the liquid silicone oil.

The developer of the invention can also contain charge controlling agents as necessary, such as metal soaps, fatty acids, and lecithin. Examples that can be cited include Nuxtra 6% Zirconium (zirconium octanoate, manufactured by Creanova).

The developer of the invention can be prepared by finely grinding the master batch obtained as described above along with dispersing agent and the liquid silicone oil in a ball mill to produce a material having a viscosity of 30 to 300 mPa·s (25° C.). The concentration of the toner solids is 40 mass % or less, preferably 10 to 25 mass %. In this embodiment, a material having a toner solids concentration of 25 mass % is contained in the developer container 31Y as the developer.

The developer described in National Publication No. 2003-508826 can be used as the developer of the invention. For details, refer to the description in this publication. In the invention, however, it is preferable for the glass transition point (Tg) of the binder resin in the developer to be 40 to 70° C.

The anilox roll 32Y functions as an application roll for supplying and applies the developer to the elastic roll 16Y. The anilox roll 32Y is a cylindrical member provided with a nonuniform surface resulting from the formation of fine, uniformly-etched, spiraling grooves in the surface so that the developer will be readily carried on the surface. Developer is supplied from the developer container 31Y to the developing roll 20Y by this anilox roll 32Y. During operation of the device, as shown in FIG. 2, the auger 34Y rotates in the counter-clockwise direction, supplying the developer to the anilox roll 32Y, and the anilox roll 32Y rotates in the clockwise direction, thereby applying developer to the elastic roll 16Y that is rotating in the counter-clockwise direction. The developer that has been applied to the elastic roll 16Y by the anilox roll 32Y is supplied to the developing roll 20Y that is rotating in the counter-clockwise direction.

The regulation blade 33Y is a metal blade with a thickness of about 200 μm and impinges upon the surface of the anilox roll 32Y, regulating the film thickness and amount of developer that is supported and transported by the anilox roll 32Y, thereby controlling the amount of developer that is supplied to the elastic roll 16Y.

The developing roll 20Y is a cylindrical member that rotates in the counter-clockwise direction as shown in FIG. 2 about it rotational axis. The developing roll 20Y has an elastic layer such as polyurethane rubber, silicone rubber, NBR, or the like, that is provided on the outer circumferential part of an inner core that is made from a metal such as iron, with a coating of PFA or urethane applied to this elastic layer. The developing roll cleaning blade 21Y is composed of rubber or the like, impinges upon the surface of the developing roll 20Y, and is disposed downstream in the direction of rotation of the developing roll 20Y from the developing nip part where the developing roll 20Y impinges upon the photosensitive body 10Y. The cleaning blade scrapes off the developer that remains on the developing roll 20Y. The developer that has been scraped off falls into the recovery reservoir part 320Y of the exposure device 30Y.

With the elastic roll 16Y as well, an elastic layer such as polyurethane rubber, silicone rubber, NBR, or the like is provided on the outer circumferential part of an inner core that is composed of metal such as iron, with a coating of PFA or urethane also provided on this elastic layer. In addition, an elastic roll cleaning blade 17Y scrapes off and removes the developer that remains on the elastic roll 16Y. The developer that has been scraped off falls into the recovery reservoir part 320Y of the exposure device 30Y.

The toner compression corona generator 22Y is electric field application means that increases the electrostatic bias at the surface of the developing roll 20Y. An electric field is applied from the side of the toner compression corona generator 22Y to the developing roll 20Y with the developer that has been transported by the developing roll 20Y at the toner compression site the toner compression corona generator 22Y as shown in FIG. 2.

The developer with the compressed toner that is supported on the developing roll 20Y is made to move towards the latent image of the photosensitive body 10Y by application of the desired electric field at the developing nip part where the developing roll 20Y impinges upon the photosensitive body 10Y, thereby developing the latent image. Next, the developer that remains after development is scraped off and removed by the developing roll cleaning blade 21Y. Droplets of developer fall into the recovery reservoir part 320Y of the developer container 31Y and are reused.

The photosensitive body squeeze device that is disposed upstream from primary transfer is disposed downstream of the developing roll 20Y opposite the photosensitive body 10Y and recovers the excess developer from the toner image that has been developed by the photosensitive body 10Y. As shown in FIG. 2, the photosensitive body squeeze device is constituted by photosensitive body squeeze rolls 13Y, 13Y′ that are composed of elastic roll members having surfaces that are coated with an elastic body and that rotate while sliding in contact with the photosensitive body 10Y and cleaning blades 14Y, 14Y′ that slide in contact while pressing against the photosensitive body squeeze rolls 13Y, 13Y′, thereby cleaning the surfaces. Fogging toner that is not needed and excess carrier are recovered from the developer that has been developed on the photosensitive body 10Y, which has the action of improving the toner particle utilization ratio during development. In this embodiment the photosensitive body squeeze device prior to primary transfer is provided with a plurality of photosensitive body squeeze rolls 13Y, 13Y′, but the device also can be constituted by a single photosensitive body squeeze roll. In addition, a configuration can also be used in which one of the plurality of photosensitive body squeeze rolls 13Y, 13Y′ is or is not in contact, depending on the state of the developer.

With the primary transfer part 50Y, the developer image that has been developed on the photosensitive body 10Y is transferred to a transfer belt 40 by the primary transfer roll 51Y. A configuration is used in which the photosensitive body 10Y and the transfer belt 40 move at the same speed, where the drive load due to rotation and movement is decreased, and any disturbance to the developed toner image by the photosensitive body 10Y is minimized.

On the downstream side from primary transfer, the photosensitive body cleaning blade 18Y that impinges upon the photosensitive body 10Y cleans remaining developer on the photosensitive body 10Y that has not been transferred. The developer that has been scraped off by the photosensitive body cleaning blade 18Y falls into a developer reserving base 280Y. A recovery auger 281Y that rotates is provided in the developer reserving base 280Y. Along with rotation of the recovery auger 281Y, the developer that is reserved in the developer reserving base 280Y is conducted to a recovered developer recovery tube 285Y and arrives at a buffer tank 530Y via the recovered developer recovery tube 285Y.

The exposure device 30Y has a concentration adjustment tank 400Y for supplying developer in which toner is dispersed in a carrier at an approximate weight ratio of 25% to the supply reservoir part 310Y in the developer container 31Y. A developer supply tube 370Y is provided between the concentration adjustment tank 400Y and the supply reservoir part 310Y, and, as a result of driving of a developer supply pump 375Y that is disposed mid-way along the developer supply tube 370Y, developer with concentration adjusted in the concentration adjustment tank 400Y is supplied to the supply reservoir part 310Y.

In addition, a developer recovery tube 371Y is provided between the concentration adjustment tank 400Y and the recovery reservoir part 320Y in the developer container 31Y. In the recovery reservoir part 320Y that reserves the developer that has been scraped off by the respective cleaning blades, the developer is conducted to the developer recovery tube 371Y when the recovery auger 321Y rotates, and the developer falls into the concentration adjustment tank 400Y.

A high-concentration developer tank 510Y stores high-concentration developer having a toner solids concentration of 35% or greater. A carrier liquid tank 520Y stores the carrier stock solution. This high-concentration developer tank 510Y, in the patent claims, is expressed as the developer supply part for supplying the developer having a higher toner concentration than the toner concentration of the developer that is contained in the accommodating part.

A high-concentration developer supply tube 511Y is provided in between the high-concentration developer tank 510Y and the concentration adjustment tank 400Y. By driving a high-concentration developer supply pump 513Y in the high-concentration developer supply tube 511Y, high-concentration developer is supplied from the high-concentration developer tank 510Y to the concentration adjustment tank 400Y. When the toner solids concentration of the developer inside the concentration adjustment tank 400Y falls below 25%, high-concentration developer is supplied to the concentration adjustment tank 400Y by driving the high-concentration developer supply pump 513Y, thereby allowing the concentration to be increased.

A carrier liquid supply tube 521Y is provided between the carrier liquid tank 520Y and the concentration adjustment tank 400Y, and carrier liquid stock solution can be supplied from the carrier liquid tank 520Y to the concentration adjustment tank 400Y by driving a carrier liquid supply pump 523Y inside the carrier liquid supply tube 521Y. When the toner solids concentration of the developer inside the concentration adjustment tank 400Y rises above 25%, the carrier liquid supply pump 523Y is driven, thereby supplying carrier liquid stock solution to the concentration adjustment tank 400Y and decreasing the concentration.

A recovered developer supply tube 531Y is provided between the concentration adjustment tank 400Y and the buffer tank 530Y that reserves the developer that has been recovered from the developer reserving base 280Y. By driving a recovered developer supply pump 533Y inside the recovered developer supply tube 531Y, recovered developer can be supplied from the buffer tank 530Y to the concentration adjustment tank 400Y.

The developer that is reserved in the buffer tank 530Y is developer that has been scraped off from the photosensitive body 10Y after secondary transfer has occurred, and thus the material is a carrier-rich material with an extremely low toner solids concentration (toner solids concentration: about 3%). Consequently, when the toner solids concentration of the developer in the concentration adjustment tank 400Y exceeds 25%, instead of supplying carrier liquid from the carrier liquid tank 520Y to the concentration adjustment tank 400Y, developer is supplied from the buffer tank 530Y to the concentration adjustment tank 400Y, thereby allowing the carrier liquid stock solution in the carrier liquid tank 520Y to be saved.

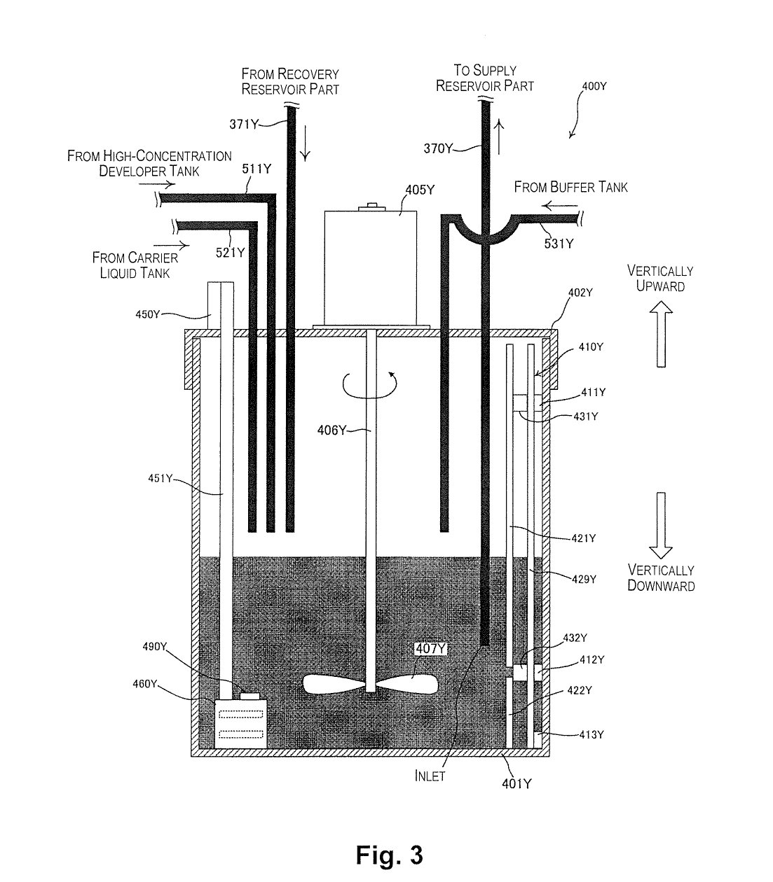

The configuration of the concentration adjustment tank 400Y is described in detail below. FIG. 3 is a sectional view showing a schematic configuration of the concentration adjustment tank in the developing device. The concentration adjustment tank 400Y is a tank that is used in order to prepare the developer that is used in the development process in the exposure device 30Y.

The concentration adjustment tank 400Y has an accommodating part 401Y that reserves developer and a lid part 402Y that covers the accommodating part 401Y and also allows insertion of various lines, a shaft part 406Y, a support member 451Y, and the like.

A motor 405Y is attached to the lid part 402Y. The shaft part 406Y which is the rotational shaft of the motor 405Y inserts into the accommodating part 401Y from the lid part 402Y. A stirring blade 407Y is attached to the shaft part 406Y at a position that is expected to be immersed in the developer. Along with operation of the motor 405Y, the stirring blade 407Y rotates, thereby stirring the developer inside the accommodating part 401Y.

An electrostatic capacity type liquid level sensor 410Y that is used in order to detect the liquid level of the developer inside the concentration adjustment tank 400Y is provided on the side surface of the accommodating part 401Y of the concentration adjustment tank 400Y. The shared electrode 429Y that constitutes the electrostatic capacity type liquid level sensor 410Y is provided along the vertical direction in a side wall part inside the concentration adjustment tank 400Y using attachment fixtures 411Y, 412Y, 413Y. The shared electrode 429Y is provided opposite a first electrode 421Y in the vertically upward direction of the shared electrode 429Y, and the shared electrode 429Y and the first electrode 421Y constitute a capacitor (“first capacitor” below). In addition, the shared electrode 429Y is provided opposite a second electrode 422 in the vertically downward direction of the shared electrode 429Y, and the shared electrode 429Y and the second electrode 422Y constitute a capacitor (“second capacitor” below). A first spacer 431Y provides positional restriction between the shared electrode 429Y and the first electrode 421Y, and a second spacer 432Y provides positional restriction between the shared electrode 429Y and the first electrode 421Y and second electrode 422Y.

In this embodiment, the shared electrode 429Y is used as the ground electrode in this manner, and two capacitors are formed in the vertically upwards part and vertically downwards part of the electrode. The first capacitor of the vertically upwards part that is formed between the shared electrode 429Y and the first electrode 421Y detects the liquid level of the developer in the concentration adjustment tank 400Y, and the second capacitor of the vertically downwards part that is formed by the shared electrode 429Y and the second electrode 422Y is adapted for acquiring a reference value for the dielectric constant of the developer.

Lead conductors not shown in the drawings are provided for the shared electrode 429Y, the first electrode 421Y, and the second electrode 422Y, allowing measurement of the electrostatic capacity of the respective capacitors.

A material such as stainless steel (SUS 304, SUS 430), iron, aluminum (A5052, A6063) or the like is used for the shared electrode 429Y, the first electrode 421Y, and the second electrode 422Y. The surfaces of the shared electrode 429Y, the first electrode 421Y, and the second electrode 422Y can be coated with polytetrafluoroethylene (product name Teflon), or the like.

Examples of the substance that is used for the first spacer 423Y and the second spacer 424Y which are the members that determine the spacing between the electrodes include insulating bodies such as polyethylene, polyethylene terephthalate, polystyrene, polypropylene, AS resin, ABS resin, polyamide, polycarbonate, and polyacetal resin.

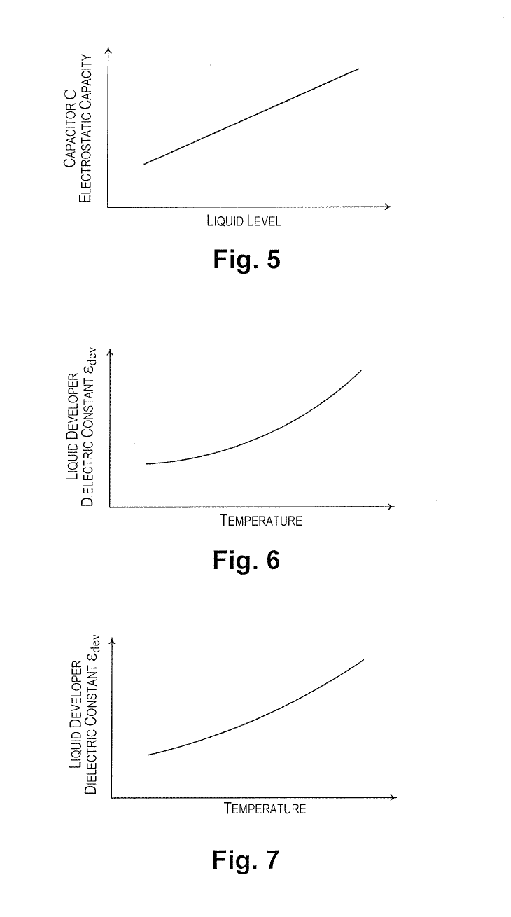

FIG. 5 is a diagram showing the relationship between electrostatic capacity and liquid level determined from the measurement principle of the first capacitor of the vertically upwards part formed by the shared electrode 429Y and the first electrode 421Y. A first-order relationship as shown in the drawing is seen between the liquid level in the concentration adjustment tank 400Y and the electrostatic capacity of the first capacitor C of the vertically upwards part formed by the shared electrode 429Y and the first electrode 421Y.

In this connection, regarding the dielectric constant ∈_{dev} of the developer that is used in this embodiment, it was found that the electrostatic capacity changes with temperature. Based on this type of change, the electrostatic capacity of the first capacitor C of the vertically upwards part formed by the shared electrode 429Y and the first electrode 421Y varies as shown in FIG. 6 in accordance with changes in temperature. The relational formula between temperature and dielectric constant ∈_{dev} in FIG. 6 is approximated by a second-order formula.

In addition, the dielectric constant ∈_{dev} of the developer that is used in this embodiment changes in accordance with the concentration of the toner solids that are dispersed in the carrier liquid. FIG. 7 is a schematic diagram of the relationship between concentration and dielectric constant ∈_{dev} of the developer. As shown in FIG. 7, the dielectric constant ∈_{dev} of the developer tends to increase as the concentration of the developer increases.

As described above, because the dielectric constant ∈_{dev} in the first capacitor C changes with the temperature and concentration of the developer in the electrostatic capacity type liquid level sensor 410Y, when the liquid level is to be computed, a correction is carried out based on changes in the dielectric constant ∈_{dev} in accordance with the temperature and the concentration.

Because the dielectric constant ∈_{dev} of the developer can be determined from the reference value that is acquired by the second capacitor of the vertically downwards part formed by the shared electrode 429Y and the second electrode 422Y, it is possible to acquire an accurate dielectric constant ∈_{dev} that takes into account the change in the temperature and concentration of the developer. By using this dielectric constant ∈_{dev}, the liquid level of the developer is computed from the electrostatic capacity obtained from the shared electrode 429Y and the first electrode 421Y, and thus an accurate liquid level can be computed.

In this manner, with the developing device and the image forming device of the invention, the electrostatic capacity that is obtained from the shared electrode 429Y and the second electrode 422Y is used as a reference value in order to determine the liquid level of the developer from the electrostatic capacity that is obtained from the shared electrode 429Y and the first electrode 421Y, and the liquid level can thus be determined while taking into account changes in the dielectric constant of the developer due to temperature or concentration. By ascertaining the liquid level of the accommodating part in accordance with the developing device and image forming device of the invention, it is possible to replenish an appropriate amount so that the developer reaches the target concentration, thereby preventing degradation of image quality.

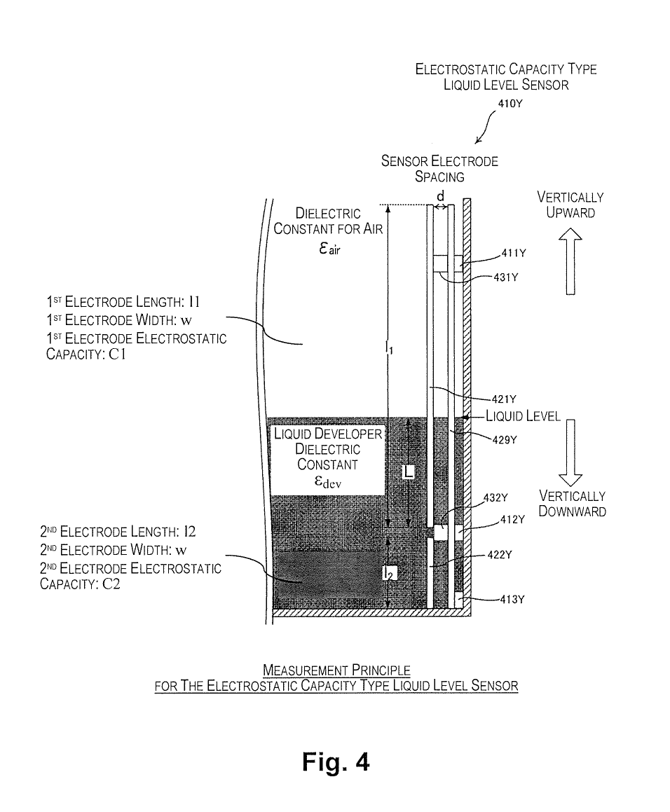

FIG. 4 is a diagram illustrating the measurement principle when the liquid level of the developer in the concentration adjustment tank 400Y is detected from the first capacitor of the vertically upwards part that is formed by the shared electrode 429Y and the first electrode 421Y. Electrodes of the same width are used for the shared electrode 429Y, the first electrode 421Y, and the second electrode 422Y, and the electrode width is denoted by “w.” In addition, the electrode length of the first electrode 421Y is l₁, and the electrode length of the second electrode 422Y is l₂. The shared electrode 429Y and the second electrode 422Y are disposed opposite each other at a spacing d. In addition, for purposes of convenience, the liquid level L is determined taking the bottom end part of the first electrode 421Y as the base point. The dielectric constant of air is represented as ∈ₐᵢᵣ, and the dielectric constant of the developer is represented as ∈_{dev}.

The electrostatic capacity of the first capacitor formed by the shared electrode 429Y and the first electrode 421Y is denoted by C1, and the electrostatic capacity of the second capacitor formed by the shared electrode 429Y and the second electrode 422Y is denoted by C2. The first capacitor is used in order to measure the liquid level, and the second capacitor is used in order to acquire the dielectric constant ∈_{dev} of the developer.

In this embodiment, the electrostatic capacity type liquid level sensor 410Y includes the first electrode 421Y (liquid level measurement), the second electrode 422Y (concentration reference), and the shared electrode 429Y (ground), and is an example in which concentration is computed while eliminating error due to the concentration of the developer. This embodiment is preferably used in cases were there is little temperature variation and the error is thought to be governed by changes in concentration.

The ∈_{dev} of the developer can be determined using formula (1) below from the electrostatic capacity measured value C2 of the second electrode 422Y.

$$\begin{matrix}[ Numerical formula 1 ] & \\ {ɛ}_{dev} = \frac{{C}_{2} d}{{wl}_{2}} & ( 1 )\end{matrix}$$

On the other hand, the electrostatic capacity computation formula for the first capacitor C1 related to the first electrode 421Y can be expressed by formula (2) below.

$$\begin{matrix}[ Numerical formula 2 ] & \\ {C}_{1} = {ɛ}_{dev} \frac{wL}{d} + {ɛ}_{air} \frac{w ( {l}_{1} - L )}{d} & ( 2 )\end{matrix}$$

From the above, the liquid level L can be determined from formula (3) below.

$$\begin{matrix}[ Numerical formula 3 ] & \\ L = \frac{( {C}_{1} - \frac{{ɛ}_{air} {wl}_{1}}{d} ) d}{w ( {ɛ}_{dev} - {ɛ}_{air} )} = \frac{Δ {C}_{1} d}{w ( {ɛ}_{dev} - {ɛ}_{air} )} & ( 3 )\end{matrix}$$

where:

$$\begin{matrix}[ Numerical formula 4 ] & \\ Δ {C}_{1} = {C}_{1} - \frac{{ɛ}_{air} {wl}_{1}}{d} = {C}_{1} - {C}_{0} & ( 4 ) \\ [ Numerical formula 5 ] & \\ {C}_{0} = \frac{{ɛ}_{air} {wl}_{1}}{d} & ( 5 )\end{matrix}$$

The electrostatic capacity when the entire length of the first electrode 421Y is in air is represented by C0. In addition, ΔC1 is the difference of the electrostatic capacity C1 with respect to C0 used as a reference. If ∈_{dev} obtained from formula (1) by measurement of the second electrode 422Y is substituted into formula (3), then it is possible to accurately compute the liquid level L from the electrostatic capacity measured value C1 associated with the first electrode 421Y.

As described above, the developer dielectric constant ∈_{dev} changes with changes in concentration, and the liquid level L cannot be accurately determined based only on the electrostatic capacity measured value for the single electrode pair associated with the first electrode 421Y. However, in this embodiment, the electrostatic capacity obtained from the second electrode 422Y is used as a reference value, and the developer dielectric constant ∈_{dev} can be computed, allowing the liquid level L to be accurately computed.

The following describes liquid level control of the developer in the concentration adjustment tank 400Y using the electrostatic capacity type liquid level sensor 410Y configured in the manner described above.

The electrostatic capacity C1 measured by the first electrode 421Y can be determined by formula (6) below.

$$\begin{matrix}[ Numerical formula 6 ] & \\ {C}_{1} = {ɛ}_{dev} \frac{wL}{d} + {ɛ}_{air} \frac{w ( {l}_{1} - L )}{d} & ( 6 )\end{matrix}$$

In addition, the electrostatic capacity C2 measured by the second electrode 422Y can be determined by formula (2) below.

$$\begin{matrix}[ Numerical formula 7 ] & \\ {C}_{2} = {ɛ}_{dev} \frac{{wl}_{2}}{d} & ( 7 )\end{matrix}$$

Given that ∈_{dev}>C1 is at its maximum value when L=11 (completely filled with developer) and is at its minimum when L=0 (completely filled with air). Substituting this into formula (6) gives the inequality shown in (8).

$$\begin{matrix}[ Numerical formula 8 ] & \\ {ɛ}_{dev} \frac{{wl}_{1}}{d} \geq {C}_{1} \geq {ɛ}_{air} \frac{{wl}_{1}}{d} & ( 8 )\end{matrix}$$

Specifically, the electrostatic capacity is a value that is in the range shown in formula (8). At this time, the length l2 of the second electrode 422Y and the length l1 of the first electrode 421Y are set so that the value of C2 is smaller than the maximum value and larger than the minimum value of C1. Specifically, the respective electrode lengths are set so that the expression shown in (9) below is satisfied.

$$\begin{matrix}[ Numerical formula 9 ] & \\ {ɛ}_{dev} \frac{{wl}_{1}}{d} > {C}_{2} = {ɛ}_{dev} \frac{{wl}_{2}}{d} > {ɛ}_{air} \frac{{wl}_{1}}{d} & ( 9 )\end{matrix}$$

Formula (10) below can be obtained from formula (9).

$$\begin{matrix}[ Numerical formula 10 ] & \\ {l}_{1} > {l}_{2} > \frac{{ɛ}_{air}}{{ɛ}_{dev}} {l}_{1} & ( 10 )\end{matrix}$$

With the aim of setting the electrode lengths 11 and 12 so as to satisfy formula (10), given that ∈ₐᵢᵣ/∈_{dev} is approximately ⅓, then if l1 is set to 80 mm and l2 is set to 40 mm, then l2=(½)×l1, satisfying the inequality l2>(∈ₐᵢᵣ/∈_{dev})×l1.

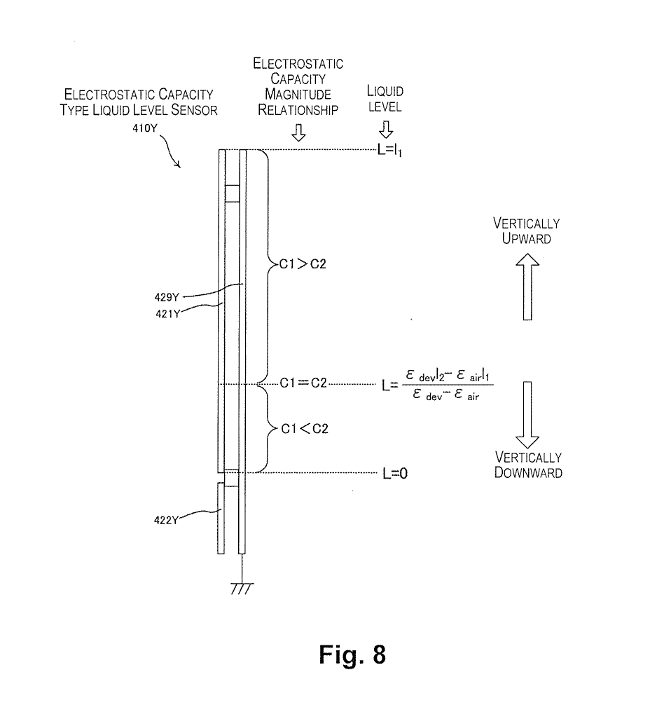

The relationship in magnitude between the electrostatic capacity C1 and electrostatic capacity C2 with respect to the value of the liquid level L is shown in FIG. 8 and in Table 1. FIG. 8 is a diagram illustrating the relationship of electrostatic capacity with respect to the liquid level. In the diagram, annotations concerning the relationship between the magnitudes of electrostatic capacity according to liquid level have been added to an extracted depiction of the first electrode 421Y, the second electrode 422Y, and the shared electrode 429Y.

TABLE 1
Relationship between liquid level and the electrostatic capacity of the
first and second electrodes.

| | Approximate magnitude relationship of |
|---|---|
| Liquid level | electrostatic capacity |
| ${L}_{1} > L > \frac{{ɛ}_{dev} {l}_{2} - {ɛ}_{air} {l}_{1}}{{ɛ}_{dev} - {ɛ}_{air}}$ | C1 > C2 |
| $L = \frac{{ɛ}_{dev} {l}_{2} - {ɛ}_{air} {l}_{1}}{{ɛ}_{dev} - {ɛ}_{air}}$ | C1 = C2 |
| $\frac{{ɛ}_{dev} {l}_{2} - {ɛ}_{air} {l}_{1}}{{ɛ}_{dev} - {ɛ}_{air}} > L > 0$ | C1 < C2 |

For example, if C1 is not greater than C2, then supply from the concentration adjustment tank 400Y to the developer container 31Y is stopped, the replenishment amount of high-concentration developer from the high-concentration developer tank 510Y is increased, and the replenishment amount of carrier liquid from the carrier liquid tank 520Y is increased, so that the liquid level is continually maintained at greater than zero, thereby ensuring that the second electrode 422Y is always in the developer.

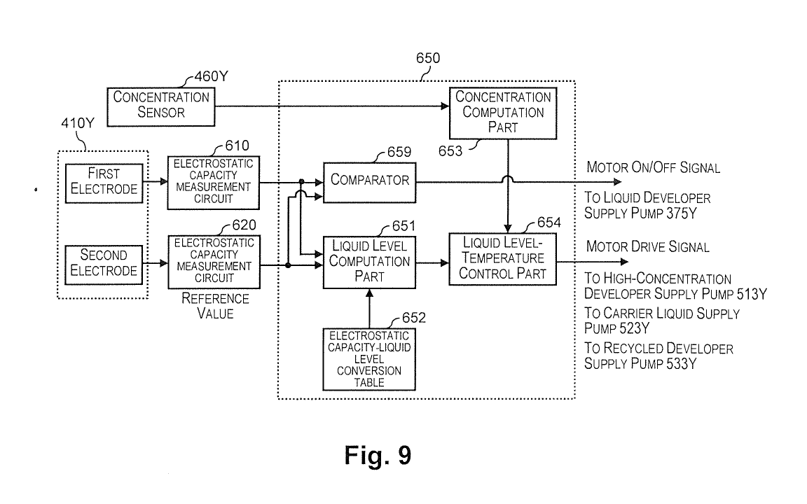

An example of liquid level control in the concentration adjustment tank 400Y will be described next. FIG. 9 is diagram showing a block configuration related to liquid level control of the developer in the concentration adjustment tank 400Y.

In FIG. 9, the microcomputer 650 is a general-purpose information processing device comprising a CPU, ROM that stores the programs to be executed by the CPU, RAM which is the work area for the CPU, and the like. Various processing parts and storage parts such as a liquid level computation part 651, an electrostatic capacity-liquid level computation table 652, a concentration computation part 653, a liquid level-concentration controller 654, and a comparator 659 can be understood as being provided virtually on the microcomputer 650.

The input from the first electrode 421Y and the second electrode 422Y that constitute the electrostatic capacity type liquid level sensor 410Y are input to an electrostatic capacity measurement circuit 610 and an electrostatic capacity measurement circuit 620, and respective electrostatic capacity data sets are produced. The electrostatic capacity measurement circuit, for example, can be a circuit having a configuration whereby a known current is supplied to the electrode for a prescribed time period to charge the capacitor, and the voltage between the electrodes is then measured, thereby acquiring the electrostatic capacity.

Electrostatic capacity data that has been detected by the first capacitor that is formed by the shared electrode 429Y and the first electrode 421Y, and electrostatic capacity data (reference data) that has been detected by the second capacitor formed by the shared electrode 429Y and the second electrode 422Y are input respectively from the electrostatic capacity measurement circuit 610 and the electrostatic capacity measurement circuit 620 to the microcomputer 650. In addition, concentration data is input from the concentration sensor 460Y to the microcomputer 650.

At the liquid level computation part 651 in the microcomputer 650, the electrostatic capacity-liquid level computation table 652 is referenced, and the liquid level is computed based on the electrostatic capacity data that has been input from electrostatic capacity measurement circuit 610 and the electrostatic capacity measurement circuit 620. The electrostatic capacity-liquid level computation table 652 is a table in which electrostatic capacity data, liquid level developer dielectric constant ∈_{dev} and liquid level data combinations are stored. This table is constructed based on formulas (1) to (5) described previously.

The data from the concentration sensor 460Y is processed by the concentration computation part 653 and is input to the liquid level-concentration controller 654. The concentration sensor 460Y and the concentration detection part 653 are described, for example, in JP (Kokai) 2009-75558, and the method for detecting the concentration can employ, for example, a transmissive concentration sensor.

The liquid level data that is output by the liquid level computation part 651 and the concentration data that is output by the concentration computation part 653 are input to the liquid level-concentration controller 654.

The liquid level-concentration controller 654 is a controller that carries out simultaneous control of the liquid level and concentration in order to maintain a constant liquid level and concentration in the concentration adjustment tank 400Y based on the liquid level data that has been computed by the liquid level computation part 651 and the concentration data that has been computed by the concentration computation part 653. The high-concentration developer and carrier replenishment amounts are computed in order to simultaneously maintain a constant liquid level and concentration. In addition, based on the computed values, a drive signal is output to the motors of the respective pumps so that liquid is transferred to the concentration adjustment tank 400Y from the high-concentration developer tank 510Y, the carrier liquid tank 520Y, and the buffer tank 530Y. As a result, correct replenishment is performed in accordance with the liquid level and concentration, and the liquid level and concentration are maintained.

The comparator 659 is a comparator that compares the electrostatic capacity C2 at the second electrode 422Y with the electrostatic capacity C1 at the first electrode 421Y that are input from the electrostatic capacity measurement circuit 610. For example, as a result of comparison, an ON signal is output to the developer supply pump 375Y when C1>C2, whereas an OFF signal is output to the developer supply pump 375Y when C1≦C2.

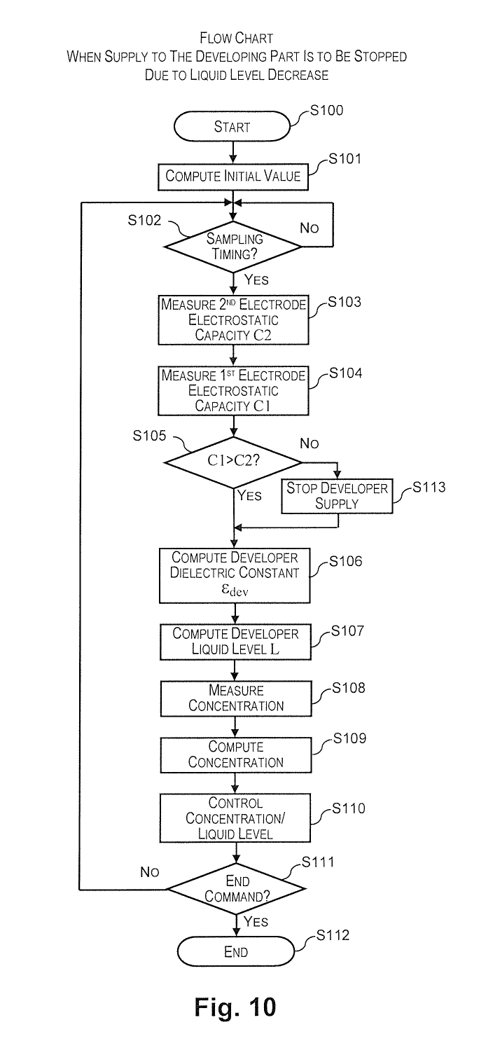

The following describes an example of control of the liquid level in the concentration adjustment tank 400Y carried out by the controller shown in the block diagram constituted as described above. FIG. 10 is a diagram showing a flow chart related to liquid level control of the developer in the concentration adjustment tank.

When processing is initiated in step S100, initial value computation is carried out in step S101. In initial value computation, the electrostatic capacity initial value C0 is computed based on formulas (4) and (5) when the entire length of the first electrode 421Y is in air. This value is used as the reference value for computing ΔC1 when calculating the liquid level.

In step S102, it is determined whether there is sampling timing, and the routine proceeds to step S103 when this determination is YES.

In step S103, electrostatic capacity measurement is carried out by the second electrode 422Y to acquire the electrostatic capacity C2, and, in the subsequent step S104, electrostatic capacity measurement is carried out by the first electrode 421Y to obtain the electrostatic capacity C1.

In step S105, the comparator 659 determines whether C1>C2. If the determination in step S105, is YES, then a condition exists in which the liquid level is sufficient, and the routine proceeds to S106 in this case.

On the other hand, when the determination in step S105 is NO, then a condition exists in which the liquid level is insufficient, and the routine proceeds to step S113, an OFF signal is output to the developer supply pump 375Y, the developer supply pump 375Y is stopped, and then control is subsequently carried out so that the amount of developer from the concentration adjustment tank 400Y is not decreased. Specifically, in step S113, supply from the concentration adjustment tank 400Y to the developer container 31Y is stopped.

In step S106, the developer dielectric constant ∈_{dev} is computed based on the electrostatic capacity C2. Next, in step S107, the electrostatic capacity-liquid level computation table 652 is referenced, and the developer liquid level data L is computed based on the electrostatic capacity C1 and the developer dielectric constant ∈_{dev}. In step S108, the concentration of the developer in the concentration adjustment tank 400Y is measured by the concentration sensor 460Y. Next, in step S109, the concentration data for the developer is computed by the concentration computation part 653 based on the data acquired by the concentration sensor 460Y.

In step S110, the liquid level-concentration controller 654 carries out simultaneous control of the liquid level and concentration based on the liquid level data and the concentration data so that the liquid level and the concentration in the concentration adjustment tank 400Y are maintained constant.

In step S111, it is determined whether or not there is a stop command from an upper-level device. If this determination is NO, then the routine loops back to step S102, whereas the routine proceeds to step S112 and processing stops if the determination is YES.

With the developing device and image forming device of the invention, supply of developer to the developer container is controlled based on the electrostatic capacity C1 detected by the first electrode 421Y and the electrostatic capacity C2 that is detected by the second electrode 422Y and used as a reference value. When a decrease in the liquid level is detected by comparing the electrostatic capacity measured by these two electrodes, transfer of liquid to the developer container 31Y is stopped, thereby suppressing a decrease in the liquid level and allowing the second electrode 422Y to be continually maintained in the developer. Because the dielectric constant of the developer is detected and a correction is carried out during liquid level computation in accordance with the electrostatic capacity that is measured by the second electrode 422Y in the developer, the precision of liquid level computation can be dramatically improved, without being influenced by changes in developer concentration or temperature.

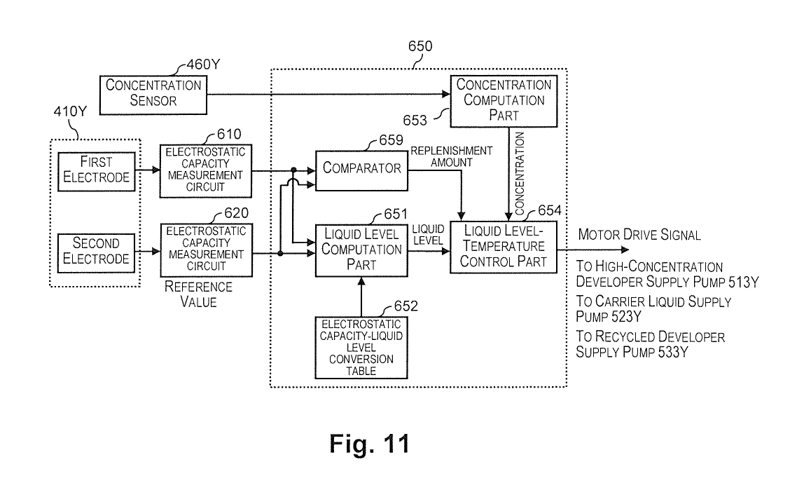

A second embodiment of the invention is described below. In the second embodiment, the control method is different from the first embodiment. The remainder of the configuration, however, is similar, and thus a detailed description will be presented concerning the control method. FIG. 11 shows a block configuration related to liquid level control in the concentration adjustment tank 400Y of the developing device pertaining to the second embodiment.

The difference between the second embodiment shown in FIG. 11 and the previous embodiment is that the comparator 659 compares the electrostatic capacity C1 of the first electrode 421Y that is input by the electrostatic capacity measurement circuit 610 and the electrostatic capacity C2 of the second electrode 422Y. For example, as a result of the comparison, a “normal” signal is output as a signal for regulating the replenishment amount when C1>C2, whereas an “increase” signal is output as a signal for regulating the replenishment amount when C1≦C2. In addition, the signal that is output from the comparator 659 is input to the liquid level-concentration controller 654. When an “increase” signal is input, the liquid level-concentration controller 654 increases the replenishment amount relative to when a “normal” signal is input by outputting a control signal whereby the rotation rate is increased for the motor (not shown) of the high-concentration developer supply pump 513, the motor (not shown) of the carrier liquid supply pump 523Y, and the motor (not shown) of the recovered developer supply pump 533Y.

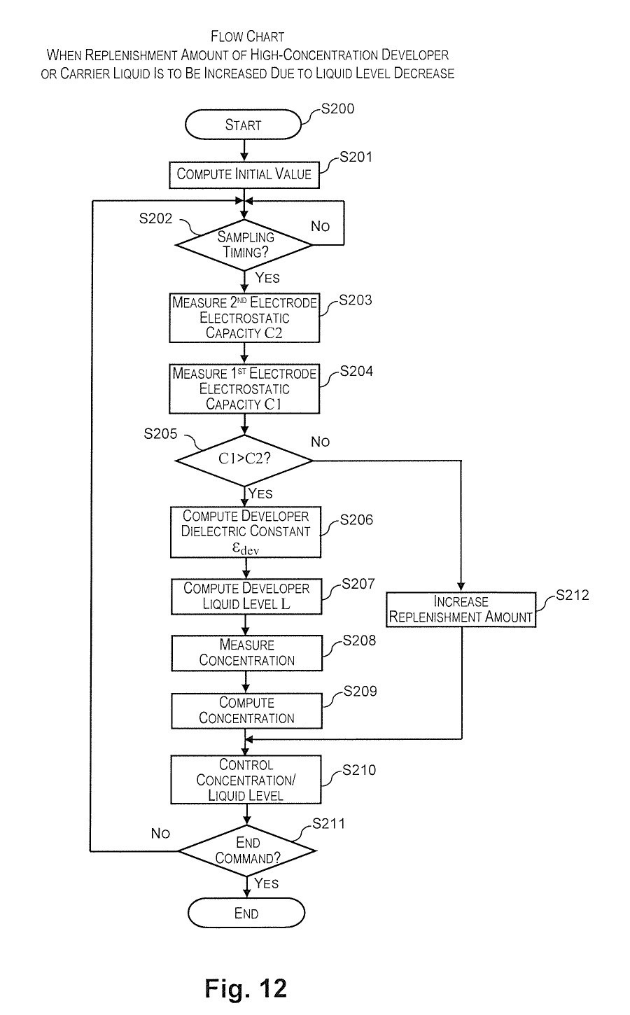

The following describes a liquid level control example for the liquid level in the concentration adjustment tank 400Y carried out by the controller shown in the block diagram configured as described above. FIG. 12 is a diagram showing a flow chart related to liquid level control in the concentration adjustment tank 400Y of the developing device pertaining to the second embodiment.

When processing is initiated in step S200, the initial value is computed in step S201. In initial value computation, the electrostatic capacity initial value C0 is computed based on formulas (4) and (5) when the entire length of the first electrode 421Y is in air. This value is used as the reference value for computing ΔC1 when calculating the liquid level.

In step S202, it is determined whether there is sampling timing, and the routine proceeds to step S203 when this determination is YES.

In step S203, electrostatic capacity measurement is carried out by the second electrode 422Y to acquire the electrostatic capacity C2, and, in the subsequent step S204, electrostatic capacity measurement is carried out by the first electrode 421Y to obtain the electrostatic capacity C1.

In step S205, the comparator 659 determines whether C1>C2. If the determination in step S205 is YES, then a condition exists in which the liquid level is sufficient, and the routine proceeds to S206 in this case.

On the other hand, when the determination in step S205 is NO, then a condition exists in which the liquid level is insufficient, and the routine proceeds to step S212. The comparator 659 outputs a replenishment amount “increase” signal to the liquid level-concentration controller 654. The liquid level-concentration controller 654 that has received this signal then sends a control signal whereby the rotation rate is increased for the motor (not shown) of the high-concentration developer supply pump 513Y, the motor (not shown) of the carrier liquid supply pump 523Y, and the motor (not shown) of the recovered developer supply pump 533Y. Subsequently, control is carried out so that the amount of developer from the concentration adjustment tank 400Y is not decreased.

In step S206, the developer dielectric constant ∈_{dev} is computed based on the electrostatic capacity C2. Next, in step S207, the electrostatic capacity-liquid level computation table 652 is referenced, and the developer liquid level data L is computed based on the electrostatic capacity C1 and the developer dielectric constant ∈_{dev}. In step S208, the concentration of the developer in the concentration adjustment tank 400Y is measured by the concentration sensor 460Y. Next, in step S209, the concentration data for the developer is computed by the concentration computation part 653 based on the data acquired by the concentration sensor 460Y.

In step S210, the liquid level-concentration controller 654 carries out simultaneous control of the liquid level and concentration based on the liquid level data and the concentration data so that the liquid level and the concentration in the concentration adjustment tank 400Y are maintained constant.

In step S211, it is determined whether or not there is a stop command from an upper-level device. If this determination is NO, then the routine loops back to step S202, whereas the routine proceeds to step S212 and processing stops if the determination is YES.

With the developing device and image forming device of the invention, supply of developer to the developer container is controlled based on the electrostatic capacity C1 that is detected by the first electrode 421Y and the electrostatic capacity C2 that is detected by the second electrode 422Y and used as a reference value. When a decrease in the liquid level is detected by comparing the electrostatic capacity measured by these two electrodes, replenishment of high-concentration developer and carrier liquid to the concentration adjustment tank 400Y is carried out, thereby suppressing a decrease in the liquid level and allowing second electrode 422Y to be continually maintained in the developer. Because the dielectric constant of the developer is detected, and a correction is carried out during liquid level computation in accordance with the electrostatic capacity that is measured by the second electrode 422Y in the developer, the precision of the liquid level computation can be dramatically improved, without being influenced by changes in developer concentration or temperature.

A third embodiment of the invention is described below. In the third embodiment, the standard used for detecting a decrease in the liquid level is different than in the embodiments described previously. In accordance with the third embodiment, a constant k is input, allowing the reference that is used for detecting a decrease in the liquid level to be more freely selected. A detailed description is presented below.

In the third embodiment, the electrostatic capacity C2 that is measured by the second electrode 422Y is replaced with a value, kC2, obtained by multiplying the electrostatic capacity C2 by a constant k. The electrode configuration in this case is the same as described above, and only the ratio of l1 and l2 is different. The length l1 of the first electrode 421Y and the length l2 of the second electrode 422Y are set so that kC2 falls between the minimum value and maximum value for C1. Specifically, the respective electrode lengths are set so that the formula shown in (11) below is satisfied.

$$\begin{matrix}[ Numerical formula 11 ] & \\ {ɛ}_{dev} \frac{{wl}_{1}}{d} > {kC}_{2} = k {ɛ}_{dev} \frac{{wl}_{2}}{d} > {ɛ}_{air} \frac{{wl}_{1}}{d} & ( 11 )\end{matrix}$$

Formula (12) below can be obtained from formula (11).

$$\begin{matrix}[ Numerical formula 12 ] & \\ {l}_{1} > {l}_{2} > \frac{{ɛ}_{air}}{k {ɛ}_{dev}} {l}_{1} & ( 12 )\end{matrix}$$

Considering settings for the electrode lengths l1 and l2 that will satisfy formula (12), if, for example, k=2, then the conditional expression will be satisfied if l1=96 mm, and l2=24 mm.

In the example of liquid level decrease detection in the first and second embodiments, the values that can be used for l1 and l2 are restricted in accordance with the developer dielectric constant ∈_{dev} and the dielectric constant of air ∈ₐᵢᵣ. In this embodiment, however, l1 and l2 can be set to desired values by changing the value for k.

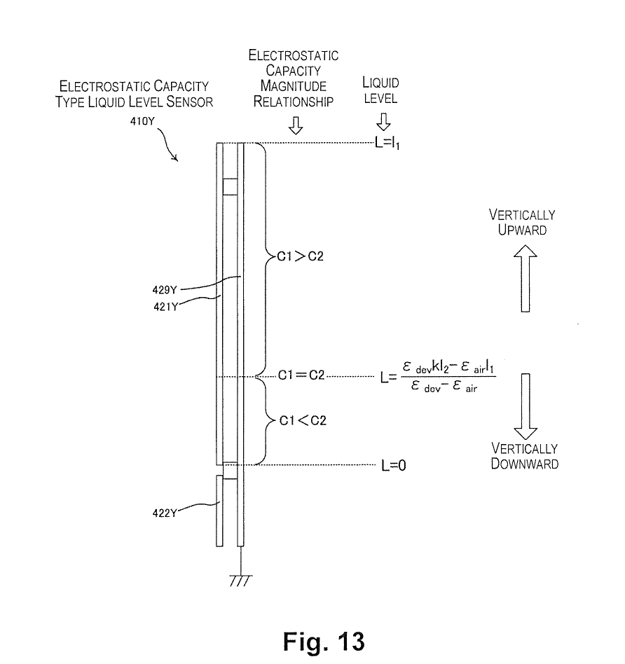

In this embodiment, the magnitude relationship of electrostatic capacity C1 and electrostatic capacity C2 in accordance with the value for the liquid level L is shown in FIG. 13 and in Table 2. FIG. 13 is a diagram illustrating the relationship between electrostatic capacity and liquid level. In the diagram notes concerning the magnitude relationship between electrostatic capacity and liquid level are added in a diagram produced by extracting the first electrode 421Y, the second electrode 422Y, and the shared electrode 429Y.

TABLE 2
Relationship between liquid level and the electrostatic capacity of the
first and second electrodes.

| | Magnitude relationship of electrostatic |
|---|---|
| Liquid level | capacity |
| ${L}_{1} > L > \frac{{ɛ}_{dev} {kl}_{2} - {ɛ}_{air} {l}_{1}}{{ɛ}_{dev} - {ɛ}_{air}}$ | C1 > C2 |
| $L = \frac{{ɛ}_{dev} {kl}_{2} - {ɛ}_{air} {l}_{1}}{{ɛ}_{dev} - {ɛ}_{air}}$ | C1 = C2 |
| $\frac{{ɛ}_{dev} {kl}_{2} - {ɛ}_{air} {l}_{1}}{{ɛ}_{dev} - {ɛ}_{air}} > L > 0$ | C1 < C2 |

In the third embodiment, for example, if C1 is not greater than kC2 when the values for C1 and kC2 are compared, then control is carried out to stop supply from the concentration adjustment tank 400Y to the developer container 31Y. The control method for stopping supply from the concentration adjustment tank 400Y to the developer container 31Y can be similar to that of the first working example. The block diagram in this case is the same as in the first working example, and the flow chart is changed so that the conditional expression in step 105 is changed from “C1>C2?” to “C1>kC2?”

In the third embodiment, for example, if C1 is not greater than kC2 when comparing C1 and kC2, then control is carried out to increase the replenishment amount of high concentration developer from the high-concentration developer tank 510Y, control is carried out to increase the replenishment amount of carrier liquid from the carrier liquid tank 520Y, and control is carried out to increase the replenishment amount of developer from the buffer tank 530Y. The control methods for increasing the replenishment amount in this manner can be the same as those used in the second embodiment. In this case, the block diagram is the same as in the second embodiment, and the flow chart is changed so that the conditional expression in step 205 is changed from “C1>C2?” to “C1>kC2?”

With control carried out as described above, the liquid level is constantly maintained at greater than 0, which ensures that the second electrode 422Y is always in the developer.

With the developing device and image forming device of the third embodiment, supply of the developer to the developer container 31Y is controlled based on the electrostatic capacity C1 that is detected by the first electrode 421Y and the electrostatic capacity C2 that is detected by the second electrode 422Y and used as a reference value. When a decrease in the liquid level is detected by comparing the electrostatic capacities measured by these two electrodes, replenishment of high-concentration developer and carrier liquid or stoppage of liquid transfer to the developer container 31Y is carried out, thereby suppressing decrease in the liquid level and allowing the second electrode 422Y to be continually maintained in the developer. Because the dielectric constant of the developer is detected and correction is carried out during liquid level computation in accordance with the electrostatic capacity that is measured by the second electrode 422Y in the developer, the precision of the liquid level computation can be dramatically improved, without being influenced by changes in developer concentration or temperature.

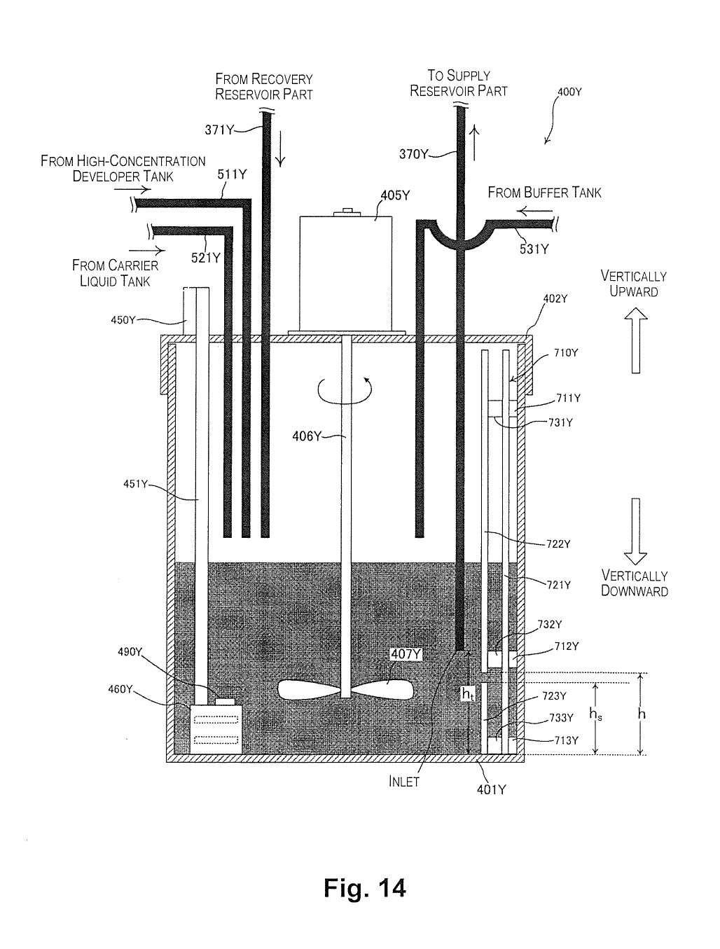

A fourth embodiment of the invention is described below. First, a detailed description will be presented concerning the configuration of the concentration adjustment tank 400Y. FIG. 14 is a sectional view showing a schematic configuration of the concentration adjustment tank in the developing device. The concentration adjustment tank 400Y is a tank that is used in order to prepare the developer that is used in the developing process in the exposure device 30Y.

The concentration adjustment tank 400Y has an accommodating part 401Y that reserves developer and a lid part 402Y that covers the accommodating part 401Y and through which various lines, a shaft part 406Y, and a support member 451Y are inserted.

A motor 405Y is attached to the lid part 402Y. The shaft part 406Y which is the rotational axis of the motor 405Y inserts into the accommodating part 401Y through the lid part 402Y. A stirring blade 407Y is attached to the shaft part 406Y at a position that is expected to be immersed in the developer, and the stirring blade 407Y rotates and stirs the developer in the accommodating part 401Y along with operation of the motor 405Y.

An electrostatic capacity liquid level sensor 710Y for detecting the liquid level of the developer in the concentration adjustment tank 400Y is provided on the side surface of the accommodating part 401Y of the concentration adjustment tank 400Y. A first electrode 721Y that constitutes the electrostatic capacity liquid level sensor 710Y is provided along the vertical direction on a side wall part in the concentration adjustment tank 400Y using attachment bases 711Y, 712Y, 713Y. The first electrode 721Y is provided opposite a second electrode 722Y in the vertically upward direction of this first electrode 721Y, and a capacitor (“first capacitor” below) is constituted by the first electrode 721Y and the second electrode 722Y. In addition, the first electrode 721Y is provided opposite a third electrode 723Y in the vertically downward direction of the first electrode 721Y, and a capacitor (“second capacitor” below) is constituted by the first electrode 721Y and the third electrode 723Y. A first spacer 731Y and a second spacer 732Y provide positional restriction between the first electrode 721Y and the second electrode 722Y, and a third spacer 733Y provides positional restriction between the first electrode 721Y and the third electrode 723Y.

In this embodiment, the first electrode 721Y is used as a shared ground electrode in this manner, and two capacitors are formed in the vertically upwards part and vertically downwards part. The first capacitor of the vertically upwards part formed by the first electrode 721Y and the second electrode 722Y detects the liquid level of the developer in the concentration adjustment tank 400Y, and the second capacitor in the vertically downwards part that is formed by the first electrode 721Y and the third electrode 723Y is used in order to acquire the dielectric constant of the developer as a reference value.

Lead conductors (not shown) are laid out for the first electrode 721Y, the second electrode 722Y, and the third electrode 723Y, allowing measurement of the electrostatic capacities of the capacitors.

A material such as stainless steel (SUS 304, SUS 430), iron, aluminum (A5052, A6063) or the like is used for the first electrode 721Y, the second electrode 722Y, and the third electrode 723Y. The surfaces of the first electrode 721Y, the second electrode 722Y, and the third electrode 723Y can be coated with polytetrafluoroethylene (product name Teflon), or the like.

Examples of the substance that is used for the first spacer 731Y, the second spacer 732Y, and the third spacer 733Y which are the members that determine the spacing between the electrodes include insulating bodies such as polyethylene, polyethylene terephthalate, polystyrene, polypropylene, AS resin, ABS resin, polyamide, polycarbonate, and polyacetal resin.

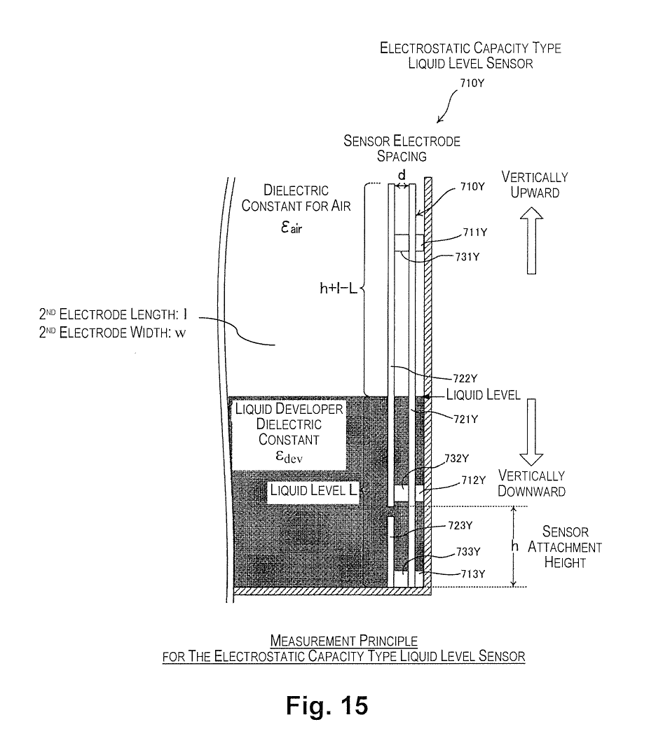

FIG. 15 is a diagram that describes the measurement principle for detecting the liquid level of the developer in the concentration adjustment tank 400Y using the first capacitor in the vertically upwards part that is formed by the first electrode 721Y and the second electrode 722Y. Electrodes having the same width are used for the first electrode 721Y, the second electrode 722Y, and the third electrode 723Y, and the electrode width is represented as w. In addition, the electrode length of the second electrode 722Y is 1, and the first electrode 721Y and the second electrode 722Y are disposed opposite each other with a separation d. In addition, the attachment height of the second electrode 722Y is h, and the liquid level is L. Thus, representing the dielectric constant of air by ∈ₐᵢᵣ and the dielectric constant of the developer by ∈_{dev}, then the capacitor Cₐᵢᵣ having air as the dielectric body can be expressed by formula (13) below.

$$\begin{matrix}[ Numerical formula 13 ] & \\ {C}_{air} = {ɛ}_{air} \frac{w ( h + l - L )}{d} & ( 13 )\end{matrix}$$

In addition, the capacitor C_{dev} with the developer as the dielectric body can be expressed by formula (14) below.

$$\begin{matrix}[ Numerical formula 14 ] & \\ {C}_{dev} = {ɛ}_{dev} \frac{w ( L - h )}{d} & ( 14 )\end{matrix}$$

Consequently, the value of the first capacitor C formed by the first electrode 721Y and the second electrode 722Y in accordance with liquid level L can be found by conversion using formula (15) below.

$$\begin{matrix}[ Numerical formula 15 ] & \\ C = {ɛ}_{dev} \frac{w ( L - h )}{d} + {ɛ}_{air} \frac{w ( h + l - L )}{d} = \frac{w ( {ɛ}_{dev } - {ɛ}_{air} )}{d} L + \frac{{ɛ}_{air} w ( l + h ) - {ɛ}_{dev} wh}{d} & ( 15 )\end{matrix}$$

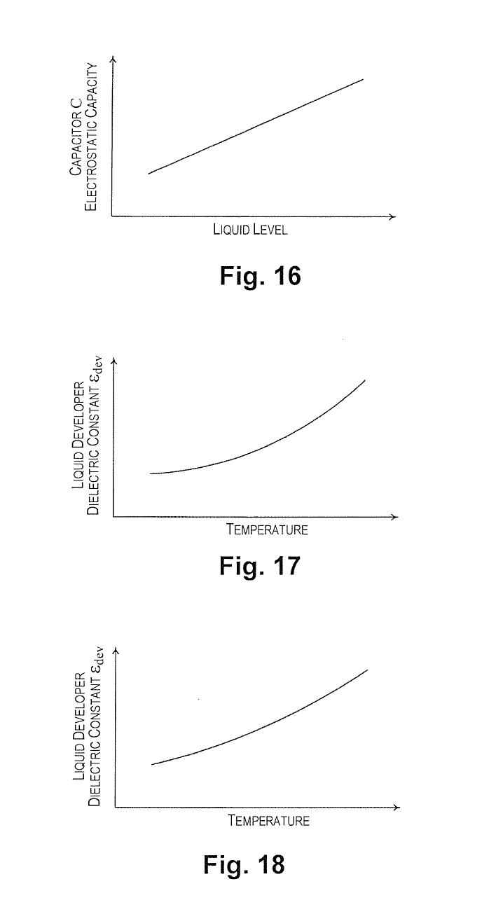

FIG. 16 shows the relationship between electrostatic capacity and liquid level determined from the measurement principle of the first capacitor of the vertically upwards part formed by the first electrode 721Y and the second electrode 722Y. From the measurement principle shown in formula (15) above, a first-order relationship as shown in the drawing is seen between the liquid level in the concentration adjustment tank 400Y and the electrostatic capacity of the first capacitor C of the vertically upwards part formed by the first electrode 721Y and the second electrode 722Y.

In this connection, regarding the dielectric constant ∈_{dev} of the developer that is used in this embodiment, it was found that the electrostatic capacity changes with temperature. Based on this type of change, the electrostatic capacity of the first capacitor C of the vertically upwards part formed by the first electrode 721Y and the second electrode 722Y varies as shown in FIG. 17 in accordance with the change in temperature. The relational formula between temperature and dielectric constant ∈_{dev} in FIG. 17 is approximated by a second-order formula.

In addition, the dielectric constant ∈_{dev} of the developer that is used in this embodiment changes in accordance with the concentration of the toner solids that are dispersed in the carrier liquid. FIG. 18 is a schematic diagram of the relationship between concentration and dielectric constant ∈_{dev} of the developer. As shown in FIG. 18, the dielectric constant ∈_{dev} of the developer tends to increase as the concentration of the developer increases.

As described above, because the dielectric constant ∈_{dev} in the first capacitor C changes with the temperature and the concentration of the developer in the electrostatic capacity type liquid level sensor 710Y, when the liquid level L is to be computed, a correction is carried out based on the change in the dielectric constant ∈_{dev} in accordance with the temperature and the concentration.

Because the dielectric constant ∈_{dev} of the developer can be determined from the reference value that is acquired by the second capacitor of the vertically downwards part formed by the first electrode 721Y and the third electrode 723Y, it is possible to acquire an accurate dielectric constant ∈_{dev} that takes into account the change in the temperature and concentration of the developer. By using this dielectric constant ∈_{dev}, the liquid level of the developer is computed from the electrostatic capacity obtained from the first electrode 721Y and the second electrode 722Y, and thus an accurate liquid level can be computed.

In this manner, with the developing device and the image forming device of the invention, the electrostatic capacity that is obtained from the first electrode 721Y and the third electrode 723Y is used as a reference value in order to determine the liquid level of the developer from the electrostatic capacity that is obtained from the first electrode 721Y and the second electrode 722Y, and the liquid level can thus be determined while taking into account changes in the dielectric constant of the developer due to temperature or concentration. By ascertaining the liquid level of the accommodating part in accordance with the developing device and image forming device of the invention, it is possible to replenish an appropriate amount so that the developer reaches the target concentration, thereby preventing degradation of image quality.

A small resistance component is necessarily present in the electrodes such as the first electrode 721Y, the second electrode 722Y, and the third electrode 7xxx23Y. If a resistance component is present in the electrodes, and current flows through them, then the voltage will decrease. When the electrodes are different, the resistance components will be different, and the reference potential will vary correspondingly with respect to the drop in voltage. In this embodiment, the first electrode 721Y is the shared ground electrode for the second electrode 722Y and the third electrode 723Y, and so the potential of the ground electrode is the same potential for the second electrode 722Y and the third electrode 723Y. It is thus possible to detect capacitance with good precision because the same ground electrode is used. Moreover, high quality can be realized because it is possible to stabilize the toner concentration of the developer.

The second electrode 722Y and the third electrode 723Y are laid out and fixed relative to the first electrode 721Y with the distance between the electrodes determined by the first spacer 731Y, the second spacer 732Y, and the third spacer 733Y. The distance between the first electrode 721Y and the second electrode 722Y thus can be made equivalent to the distance between the first electrode 721Y and the third electrode 723Y. As a result, the electrostatic capacity can be computed with favorable precision, allowing the liquid level to be detected with favorable precision. Moreover, the toner concentration is stable, allowing high quality to be realized. Moreover, because the first electrode 721Y is a shared ground electrode, the number of members and conductors is decreased, and costs can be reduced.

In detecting the liquid level with favorable precision, it is necessary to measure the dielectric constant ∈_{dev} of the developer and to perform a correction on the liquid level. With this embodiment, when the liquid level is measured, the capacity between the first electrode 721Y and the second electrode 722Y is measured. If the liquid level is up to the second electrode 722Y, then the third electrode 723Y will necessarily be in the liquid. For this reason, when measuring the liquid level, it is possible to use the dielectric constant ∈_{dev} of the developer that is obtained from the second capacitor that is formed by the first electrode 721Y and the third electrode 723Y as a reference. As a result, the liquid level can be computed with favorable precision, and the toner concentration of the developer can be controlled so as to remain stable, thereby allowing high quality to be realized.

Returning to FIG. 14, a fixing member 450Y is provided on the lid part 402Y, and a concentration sensor 460Y and a temperature sensor 490Y are provided on a support member 451Y that extends from the fixing member 450Y in a form whereby it inserts through the lid part 402Y.

Examples of the concentration sensor 460Y include sensors in which ultrasonic waves are generated and received by two piezo element plates that are disposed opposite each other, and the concentration is measured from the transmission time. In addition, the temperature sensor 490Y can be a temperature detection means such as a platinum sensor.

The detection signals from the electrostatic capacity liquid level sensor 710Y, the concentration sensor 460Y, and the temperature sensor 490Y can be taken off from the concentration adjustment tank 400Y by lead wires not shown in the drawings.

The dimensional relationships in the concentration adjustment tank 400Y of this type are described below. As shown in FIG. 14, hₜ represents the height, from the bottom surface part of the accommodating part 401Y, of the inlet of the developer supply tube 370Y for supplying developer to the developer container 31Y by sucking up developer from the accommodating part 401Y. In addition, hₛ represents the height from the bottom surface part of the accommodating part 401Y to the upper surface of the third electrode 723Y.

The image forming device pertaining to this embodiment has the following defining features. With the image forming device pertaining to this embodiment, the third electrode 723Y is disposed vertically below the inlet of the developer supply tube 370Y for supplying developer to the developer container 31Y by sucking up the developer from the accommodating part 401Y.

The dimensional relationship is expressed as hₛ<hₜ. The third electrode 723Y measures the ∈_{dev} of the developer, and thus it is necessary to maintain a condition in which it is immersed in developer. However, if the third electrode 723Y is positioned vertically below the inlet of the developer supply tube 370Y that suctions up developer from the accommodating part 401Y, then an advantage is presented in that this condition will be maintained.

In this manner, in accordance with the invention, it is possible to correct the results of detection by the electrostatic capacity liquid level sensor 710Y based on changes in dielectric constant ∈_{dev} by providing a third electrode 723Y that is disposed vertically below the inlet of the developer supply tube 370Y and that detects the concentration of the developer. As a result, it is possible to acquire accurate liquid level information.

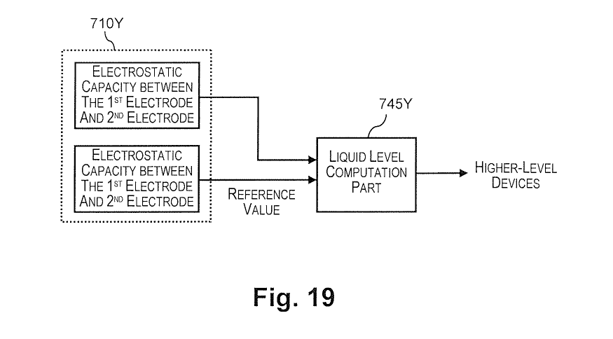

The following describes the method for computing the liquid level of the developer in the concentration adjustment tank 400Y of the exposure device 30Y of the embodiment having the configuration described above. FIG. 19 shows a block configuration related to computation of the liquid level of the developer in the concentration adjustment tank 400Y.

In FIG. 19, a liquid level computation part 745Y is a general-purpose information processing device including a CPU, a ROM that stores the programs that are executed by the CPU, RAM which is the work area for the CPU, and the like. The electrostatic capacity data that is detected by the first capacitor that is formed by the first electrode 721Y and the second electrode 722Y and the electrostatic capacity data (reference data) that is detected by the second capacitor formed by the first electrode 721Y and the third electrode 723Y are input to the liquid level computation part 745Y.

The liquid level computation part 745Y, computes the liquid level of the developer that is contained in the accommodating part 401Y based on the input data as described above and transmits liquid level data that is computed by a higher-level control device that controls the high-concentration developer supply pump 513Y, the carrier liquid supply pump 523Y, and the recovered developer supply pump 533Y.

In the developing device and the image forming device of the invention, the electrostatic capacity that is obtained from the first electrode 721Y and the third electrode 723Y is used as a reference value for determining the liquid level of the developer from the electrostatic capacity that is obtained from the first electrode 721Y and the second electrode 722Y. As a result, the liquid level is determined taking into account changes in the dielectric constant of the developer due to temperature and concentration. By ascertaining the liquid level of the accommodating part in accordance with the developing device and image forming device of the invention, it is possible to replenish an appropriate amount so that the developer reaches the target concentration, thereby preventing degradation of image quality.

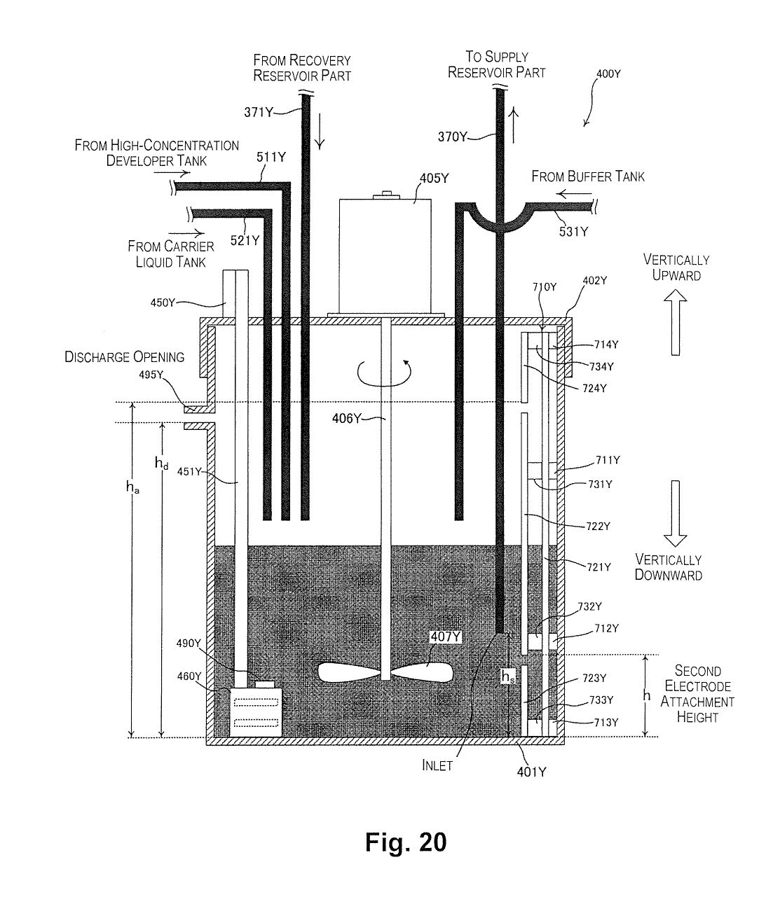

A fifth embodiment of the invention will be described next. In this embodiment, only the configuration of the concentration adjustment tank 400Y is different from the previous embodiments, and thus the description will focus on this point. FIG. 20 is a sectional view showing the schematic configuration of the concentration adjustment tank 400Y in a developing device pertaining to the fifth embodiment.

An electrostatic capacity liquid level sensor 710Y that is used for detecting the liquid level of the developer of the concentration adjustment tank 400Y is provided on a side surface of the accommodating part 401Y of the concentration adjustment tank 400Y of the fifth embodiment. A first electrode 721Y that constitutes the electrostatic capacity liquid level sensor 710Y is provided along the vertical direction on a sidewall part of the concentration adjustment tank 400Y using attachment bases 711Y, 712Y, 713Y, 714Y. The first electrode 721Y is provided opposite the fourth electrode 724Y in the vertically upward direction of the first electrode 721Y, and a capacitor (third capacitor below) is constituted by the first electrode 721Y and the fourth electrode 724Y. In addition, the first electrode 721Y is opposite the third electrode 723Y in the vertically downward direction of the first electrode 721Y, and a capacitor (“second capacitor” below) is constituted by the first electrode 721Y and the third electrode 723Y. In addition, a capacitor (“first capacitor” below) is constituted by the second electrode 722Y and the first electrode 721Y that are provided in between the third electrode 723Y and the fourth electrode 724Y.

The first spacer 731Y and the second spacer 732Y provide positional restriction between the first electrode 721Y and the second electrode 722Y, and the third space 733Y provides positional restriction between the first electrode 721Y and the third electrode 723Y. In addition, the fourth spacer 734Y provides positional restriction between the first electrode 721Y and the fourth electrode 724Y.

The first capacitor and the second capacitor have the same functions as in the previous embodiment, but the third capacitor that is formed by the first electrode 721Y and the fourth electrode 724Y has the function of measuring the dielectric constant ∈ₐᵢᵣ of air. In this embodiment, the dielectric constant ∈ₐᵢᵣ of air obtained by the third capacitor and the dielectric constant ∈_{dev} obtained by the second capacitor are used in order to compute the liquid level of the developer from the electrostatic capacity that is obtained by the first electrode 721Y and the second electrode 722Y, and thus a more accurate liquid level can be computed.

In addition, a discharge opening 495Y for discharging the developer is provided in the accommodating part 401Y of the concentration adjustment tank 400Y. Specifically, in the accommodating part 401Y, the liquid level of the developer is higher than the height h_{d} of the discharge opening 495Y. In addition, the minimum position hₐ of the fourth electrode 724Y that constitutes the third capacitor is set so that it is higher than the height h_{d}.

In terms of a dimensional relationship, this corresponds to the relationship h_{d}<h_{d}. Because the dielectric constant ∈ₐᵢᵣ of the developer is measured by the fourth electrode 724Y, it is necessary to maintain the electrode in a condition whereby it is exposed to air. However, if the fourth electrode 724Y is positioned vertically above the discharge opening 495Y that discharges the developer from the accommodating part 401Y, an advantage is presented in that this condition will be maintained.

With the developing device and the image forming device of the other embodiments, the electrostatic capacity obtained form the first electrode 721Y and the third electrode 723Y and the electrostatic capacity obtained from the first electrode 721Y and the fourth electrode 724Y are used as reference values, and the liquid level of the developer is determined from the electrostatic capacity that is obtained by the first electrode 721Y and the second electrode 722Y. Thus, the liquid level can be determined while taking into account changes in the dielectric constant of the developer due to temperature or concentration. By ascertaining the liquid level of the accommodating part in accordance with the developing device and image forming device of the invention, it is possible to replenish an appropriate amount so that the developer reaches the target concentration, thereby preventing degradation of image quality.

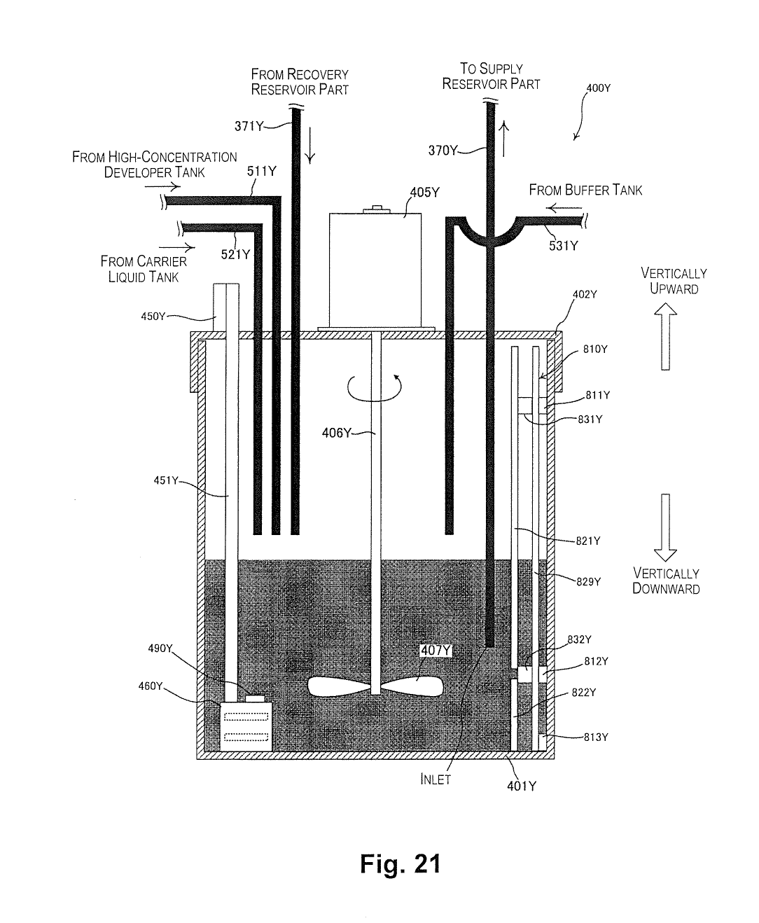

A sixth embodiment of the invention is described below. The configuration of the concentration adjustment tank 400Y will first be described in detail. FIG. 21 is a sectional view showing the schematic configuration of the concentration adjustment tank of the developing device. The concentration adjustment tank 400Y is a tank that is used in order to prepare the developer that is used in the developing process in the exposure device 30Y.

The concentration adjustment tank 400Y has an accommodating part 401Y for storing the developer and a lid part 402Y that covers the accommodating part 401Y and through which various lines, a shaft part 406Y, and a support member 451Y are inserted.

A motor 405Y is attached to the lid part 402Y. The shaft part 406Y which is the rotational axis of the motor 405Y inserts into the accommodating part 401Y through the lid part 402Y. A stirring blade 407Y is attached to the shaft part 406Y at a position that is expected to be immersed in the developer, and the stirring blade 407Y rotates and stirs the developer in the accommodating part 401Y along with operation of the motor 405Y.

An electrostatic capacity liquid level sensor 810Y for detecting the liquid level of the developer in the concentration adjustment tank 400Y is provided on the side surface of the accommodating part 401Y of the concentration adjustment tank 400Y. A shared electrode 829Y that constitutes the electrostatic capacity liquid level sensor 810Y is provided along the vertical direction on a side wall part in the concentration adjustment tank 400Y using attachment bases 811Y, 812Y, 813Y. The shared electrode 829Y is provided opposite a first electrode 821Y in the vertically upward direction of this shared electrode 829Y, and a capacitor (“first capacitor” below) is constituted by the first electrode 829Y and the first electrode 821Y. In addition, the shared electrode 829Y is provided opposite a second electrode 822Y in the vertically downward direction of the shared electrode 829Y, and the shared electrode 829Y and the second electrode 822Y constitute a capacitor (“second capacitor” below). A first spacer 831Y provides positional restriction between the shared electrode 829Y and the first electrode 831Y, and a second spacer 832Y provides positional restriction between the shared electrode 829Y, the first electrode 821Y, and the second electrode 822Y

In this embodiment, the shared electrode 829Y is used as a ground electrode in this manner, and two capacitors are formed in the vertically upwards part and vertically downwards part. The first capacitor of the vertically upwards part formed by the shared electrode 829Y and the first electrode 821Y detects the liquid level of the developer in the concentration adjustment tank 400Y, and the second capacitor in the vertically downwards part that is formed by the shared electrode 829Y and the second electrode 822Y acquires the dielectric constant of the developer as a reference value.

Lead conductors that are not shown in the drawings are laid out for the shared electrode 829Y, the first electrode 821Y, and the second electrode 822Y, allowing measurement of the electrostatic capacities of the capacitors.

A material such as stainless steel (SUS 304, SUS 430), iron, aluminum (A5052, A6063) or the like is used for the shared electrode 829Y, the first electrode 821Y, and the second electrode 822Y. The surfaces of the shared electrode 829Y, the first electrode 821Y, and the second electrode 822Y can be coated with polytetrafluoroethylene (product name Teflon), or the like.

Examples of the substance that is used for the first spacer 831Y and the second spacer 832Y which are the members that determine the spacing between the electrodes include insulating bodies such as polyethylene, polyethylene terephthalate, polystyrene, polypropylene, AS resin, ABS resin, polyamide, polycarbonate, and polyacetal resin.

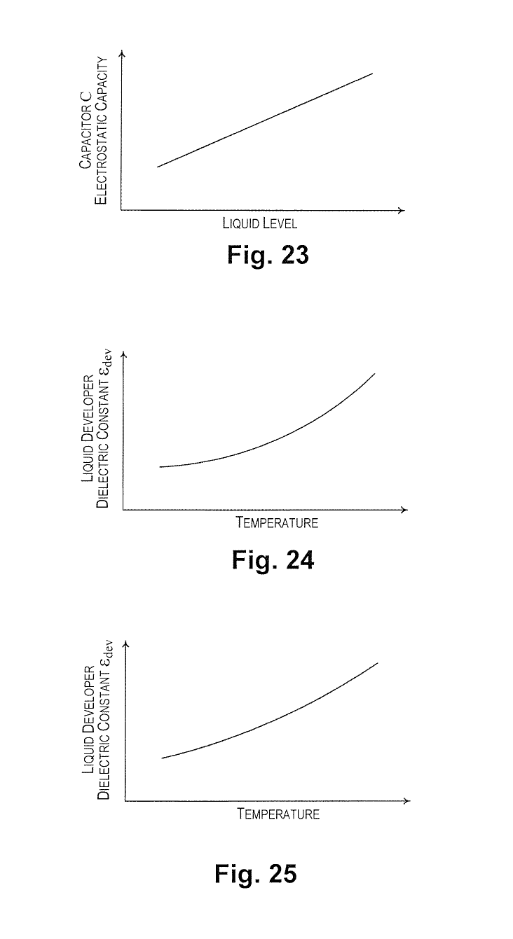

FIG. 23 is a diagram showing the relationship between electrostatic capacity and liquid level determined from the measurement principle of the first capacity in the vertically upwards part formed by the shared electrode 829Y and the first electrode 821Y. A first-order relationship as shown in the drawing is seen between the liquid level in the concentration adjustment tank 400Y and the electrostatic capacity of the first capacitor C of the vertically upwards part formed by the shared electrode 829Y and the first electrode 821Y.

In this connection, regarding the dielectric constant ∈_{dev} of the developer that is used in this embodiment, it was found that the electrostatic capacity changes with temperature. Based on this type of change, the electrostatic capacity of the first capacitor C of the vertically upwards part formed by the shared electrode 829Y and the first electrode 821Y varies in accordance with changes in temperature as shown in FIG. 24. The relational formula between temperature and dielectric constant ∈_{dev} in FIG. 24 is approximated by a second-order formula.

In addition, the dielectric constant ∈_{dev} of the developer that is used in this embodiment changes in accordance with the concentration of the toner solids that are dispersed in the carrier liquid. FIG. 25 is a schematic diagram of the relationship between concentration and dielectric constant ∈_{dev} of the developer. As shown in FIG. 25, the dielectric constant ∈_{dev} of the developer tends to increase as the concentration of the developer increases.

As described above, because the dielectric constant ∈_{dev} in the first capacitor C changes with the temperature and concentration of the developer in the electrostatic capacity type liquid level sensor 410Y, when the liquid level is to be computed, a correction is carried out based on the change in dielectric constant ∈_{dev} in accordance with temperature and concentration.

Because the dielectric constant ∈_{dev} of the developer can be determined from the reference value that is acquired by the second capacitor of the vertically downwards part formed by the shared electrode 829Y and the second electrode 822Y, it is possible to acquire an accurate dielectric constant ∈_{dev} that takes into account the change in the temperature and concentration of the developer. By using this dielectric constant ∈_{dev}, the liquid level of the developer is computed from the electrostatic capacity obtained from the shared electrode 829Y and the first electrode 821Y, and thus an accurate liquid level can be computed.

In this manner, with the developing device and the image forming device of the invention, the electrostatic capacity that is obtained from the shared electrode 829Y and the second electrode 822Y is used as a reference value in order to determine the liquid level of the developer from the electrostatic capacity that is obtained from the shared electrode 829Y and the first electrode 821Y, and the liquid level can thus be determined while taking into account changes in the dielectric constant of the developer due to temperature or concentration. By ascertaining the liquid level of the accommodating part in accordance with the developing device and image forming device of the invention, it is possible to replenish an appropriate amount so that the developer reaches the target concentration, thereby preventing degradation of image quality.

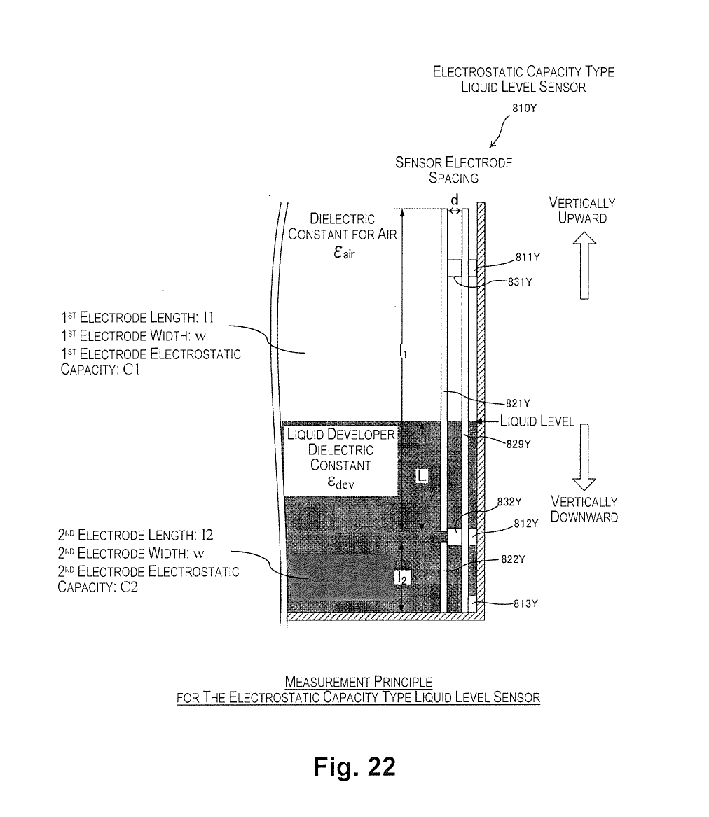

FIG. 22 is a diagram illustrating the measurement principle when the liquid level of the developer in the concentration adjustment tank 400Y is detected from the first capacitor of the vertically upwards part that is formed by the shared electrode 829Y and the first electrode 821Y. Electrodes of the same width are used for the shared electrode 829Y, the first electrode 821Y, and the second electrode 822Y, and the electrode width is denoted by “w”. In addition, the electrode length of the first electrode 821Y is l₁, and the electrode length of the second electrode 822Y is l₂. The shared electrode 829Y and the first electrode 821Y are disposed opposite each other at a spacing d. Similarly, the shared electrode 829Y and the second electrode 822Y are disposed opposite each other at a spacing d. In addition, for purposes of convenience, the liquid level L is determined taking the bottom end part of the first electrode 821Y as the base point. The dielectric constant of air is represented as ∈ₐᵢᵣ, and the dielectric constant of the developer is represented as ∈_{dev}.

The electrostatic capacity of the first capacitor formed by the shared electrode 829Y and the first electrode 821Y is denoted by C1, and the electrostatic capacity of the second capacitor formed by the shared electrode 829Y and the second electrode 822Y is denoted by C2. The first capacitor is used in order to measure the liquid level, and the second capacitor is used in order to acquire the dielectric constant ∈_{dev} of the developer.

In this embodiment, the electrostatic capacity type liquid level sensor 810Y includes the first electrode 821Y (liquid level measurement), the second electrode 822Y (concentration reference), and the shared electrode 829Y (ground), and is a concentration computation example in which error due to the concentration of the developer is eliminated. This embodiment is preferably used in cases where there is little temperature variation, and the error is thought to be governed by changes in concentration.

The ∈_{dev} of the developer can be determined using formula (16) below from the electrostatic capacity measured value C2 of the second electrode 822Y.

$$\begin{matrix}[ Numerical formula 16 ] & \\ {ɛ}_{dev} = \frac{{C}_{2} d}{w {l}_{2}} & ( 16 )\end{matrix}$$

On the other hand, the electrostatic capacity computation formula for the first capacitor C1 related to the first electrode 821Y can be expressed by formula (17) below.

$$\begin{matrix}[ Numerical formula 17 ] & \\ {C}_{1} = {ɛ}_{dev} \frac{wL}{d} + {ɛ}_{air} \frac{w ( {l}_{1} - L )}{d} & ( 17 )\end{matrix}$$

From the above, the liquid level L can be determined from formula (18) below.

$$\begin{matrix}[ Numerical formula 18 ] & \\ L = \frac{( {C}_{1} - \frac{{ɛ}_{air} {wl}_{1}}{d} ) d}{w ( {ɛ}_{dev} - {ɛ}_{air} )} = \frac{Δ {C}_{1} d}{w ( {ɛ}_{dev} - {ɛ}_{air} )} & ( 18 )\end{matrix}$$

where:

$$\begin{matrix}[ Numerical formula 19 ] & \\ Δ {C}_{1} = {C}_{1} - \frac{{ɛ}_{air} {wl}_{1}}{d} = {C}_{1} - {C}_{0} & ( 19 ) \\ [ Numerical formula 20 ] & \\ {C}_{0} = \frac{{ɛ}_{air} {wl}_{1}}{d} & ( 20 )\end{matrix}$$

The electrostatic capacity when the entire length of the first electrode 821Y is in air is represented by C0. In addition, ΔC1 is the difference of the electrostatic capacity C1 with respect to C0 used as a reference. If ∈_{dev} obtained from formula (16) using the measurement of the second electrode 822Y is substituted into formula (18), then it is possible to accurately compute the liquid level L from the electrostatic capacity measured value C1 associated with the first electrode 821Y.

As described above, the developer dielectric constant ∈_{dev} changes with changes in concentration, and the liquid level L cannot be accurately determined based only on the electrostatic capacity measured value for the single electrode pair associated with the first electrode 821Y. However, in this embodiment, the electrostatic capacity obtained from the second electrode 822Y is used as a reference value, and the developer dielectric constant ∈_{dev} can be computed, allowing the liquid level L to be accurately computed.

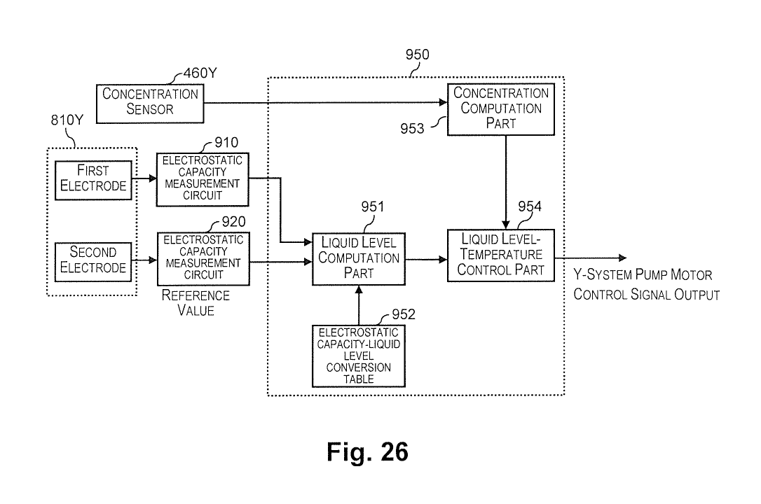

The following describes an example of liquid level control in the developing device 30Y configured in the manner described above. FIG. 26 is diagram showing a block configuration related to computation of the liquid level of the developer in the concentration adjustment tank 400Y. In FIG. 26, the microcomputer 950 is a general-purpose information processing device including a CPU, ROM that stores the programs to be executed by the CPU, RAM which is the work area for the CPU, and the like. Various processing parts and storage parts such as a liquid level computation part 951, an electrostatic capacity-liquid level computation table 952, a concentration computation part 953, a liquid level-concentration controller 954, and the like can be understood as being provided virtually on the microcomputer 950.

The input from the first electrode 821Y and the second electrode 822Y that constitute the electrostatic capacity type liquid level sensor 810Y are input into an electrostatic capacity measurement circuit 910 and an electrostatic capacity measurement circuit 920, and respective electrostatic capacity data sets are produced. The electrostatic capacity measurement circuit, for example, can be a circuit having a configuration whereby a known current is supplied to the electrode for a prescribed time period to charge the capacitor, and the voltage between the electrodes is then measured, thereby acquiring the electrostatic capacity.

Electrostatic capacity data that has been detected by the first capacitor that is formed by the shared electrode 829Y and the first electrode 821Y, and electrostatic capacity data (reference data) that has been detected by the second capacitor formed by the shared electrode 829Y and the second electrode 822Y are input respectively from the electrostatic capacity measurement circuit 910 and the electrostatic capacity measurement circuit 920 into the microcomputer 950. In addition, concentration data is input from the concentration sensor 460Y to the microcomputer 950.

At the liquid level computation part 951 in the microcomputer 950, the electrostatic capacity-liquid level computation table 952 is referenced, and the liquid level is computed based on the electrostatic capacity data that has been input from electrostatic capacity measurement circuit 910 and the electrostatic capacity measurement circuit 920. The electrostatic capacity-liquid level computation table 952 is a table in which two sets of electrostatic capacity data and liquid level data combinations are stored. This table is constructed based on formulas (16) to (20) described previously.

The data from the concentration sensor 460Y is processed by the concentration computation part 953 and is input to the liquid level-concentration controller 954. The concentration sensor 960Y and the concentration detection part 953 are described, for example, in JP (Kokai) 2009-75558, and the method for detecting the concentration can employ, for example, a transmissive concentration sensor.

The liquid level data that is output by the liquid level computation part 951 and the concentration data that is output by the concentration computation part 953 are input to the liquid level-concentration controller 954.

The liquid level-concentration controller 954 is a controller that carries out simultaneous control of the liquid level and concentration in order to maintain a constant liquid level and concentration in the concentration adjustment tank 400Y based on the liquid level data that has been computed by the liquid level computation part 951 and the concentration data that has been computed by the concentration computation part 953. The high-concentration developer and carrier replenishment amounts are computed in order to simultaneously maintain a constant liquid level and concentration. In addition, based on the computed values, a drive signal is output to the motors of the respective pumps so that liquid is transferred to the concentration adjustment tank 400Y from the high-concentration developer tank 510Y, the carrier liquid tank 520Y, and the buffer tank 530Y. As a result, correct replenishment is performed in accordance with the liquid level and concentration, and the liquid level and concentration are maintained.

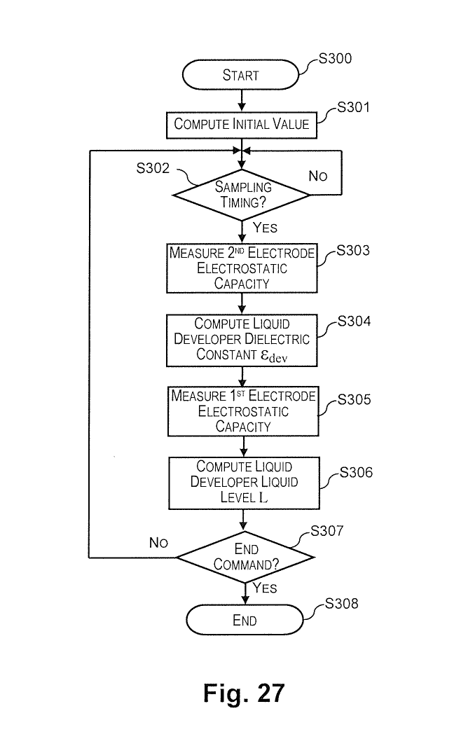

FIG. 27 is a flow chart for calculating the liquid level of the developer in the concentration adjustment tank. When processing is initiated in step S300, initial value computation is carried out in step S301. In initial value computation, the electrostatic capacity initial value C0 is computed based on formulas (19) and (20) when the entire length of the first electrode 821Y is in air. This value is used as the reference value for computing ΔC1 when calculating the liquid level.

In step S302, it is determined whether there is sampling timing, and the routine proceeds to step S303 when this determination is YES.

In step S303, electrostatic capacity measurement is carried out by the second electrode 822Y. In the next step, S304, the developer dielectric constant ∈_{dev} is computed based on this measurement. In addition, in step S305, electrostatic capacity measurement is carried out by the first electrode 821Y, and, in step S306, the developer liquid level L is then computed referencing the electrostatic capacity-liquid level computation table 952.

In step S307, it is determined whether or not there is a stop command from an upper-level device. If this determination is NO, then the routine loops back to step S302, whereas the routine proceeds to step S308 and processing stops if the determination is YES.

With the developing device and image forming device of the invention, the liquid level of the developer is determined from the electrostatic capacity that is obtained from the first electrode 821Y using the second electrostatic capacity detected by the second electrode 822Y as a reference value, and the liquid level can thus be determined while taking into account changes in the dielectric constant of the developer due to temperature or concentration. By ascertaining the liquid level of the accommodating part 401Y in accordance with the developing device and image forming device of the invention, it is possible to replenish an appropriate amount so that the developer reaches the target concentration, thereby preventing degradation of image quality.

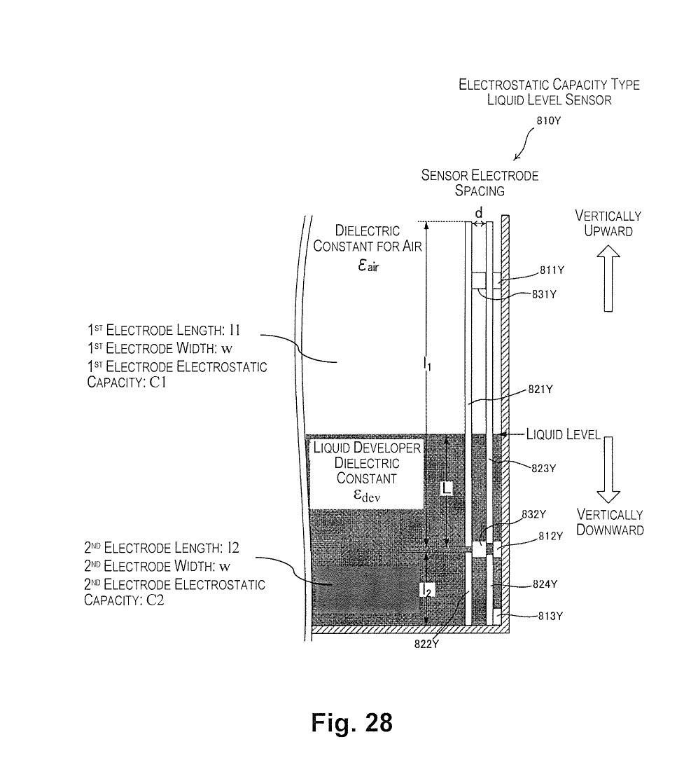

A seventh embodiment of the invention is described below. The seventh embodiment is different from the previous embodiments in regard to the configuration of the electrostatic capacity type liquid level sensor 810Y that is provided in the concentration adjustment tank 400Y. The following description will thus focus on the electrostatic capacity type liquid level sensor 810Y pertaining to the seventh embodiment. FIG. 28 is a diagram illustrating the electrostatic capacity type liquid level sensor 810Y of the developing device pertaining to the seventh embodiment of the invention.

In the previous embodiments, the first capacitor was formed by the shared electrode 829Y and the first electrode 821Y, and the second capacitor was formed by the shared electrode 829Y and the second electrode 822Y. However, in the seventh embodiment, the first electrode is formed by a first electrode 821Y and an opposing third electrode 823Y in the vertically upwards part of the concentration adjustment tank 400Y, and the second capacitor is formed by a second electrode 822Y and an opposing fourth electrode 824Y in the vertically downwards part of the concentration adjustment tank 400Y. Specifically, in the first embodiment, a total of three electrodes were used, including a shared electrode, to form two capacitors. In the seventh embodiment, a total of four electrodes are used to form two capacitors. In addition, the lengths of the first electrode 821Y and the third electrode 823Y are L₁ and the widths are w, whereas the lengths of the second electrode 822Y and the fourth electrode 824Y are L₂ and the widths are 4w.

In this embodiment, ∈_{dev} of the developer can be determined using formula (21) below from the electrostatic capacity measured value C2 of the second electrode 822Y and the fourth electrode 824Y.

$$\begin{matrix}[ Numerical formula 21 ] & \\ {ɛ}_{dev} = \frac{{C}_{2} d}{{wl}_{x}} & ( 21 )\end{matrix}$$

In this embodiment, the widths of the second electrode 822Y and the fourth electrode 824Y are four times the widths of the first electrode 821Y and the third electrode 823Y, and thus the computation prevision for ∈_{dev} of the developer can be improved.

In the seventh embodiment, the other parameters are the same as in the first embodiment, and the liquid level L can be computed using the computational formulas that are similar to those of the sixth embodiment, substituting formula (21) for formula (16).

With the developing device and the image forming device of the seventh embodiment, the liquid level of the developer is determined from the electrostatic capacity that is obtained from the first electrode 821Y using the second electrostatic capacity detected by the second electrode 822Y as a reference value, and the liquid level can thus be determined while taking into account changes in the dielectric constant of the developer due to temperature or concentration. By ascertaining the liquid level of the accommodating part 401Y in accordance with the developing device and image forming device of the invention, it is possible to replenish an appropriate amount so that the developer reaches the target concentration, thereby preventing degradation of image quality.

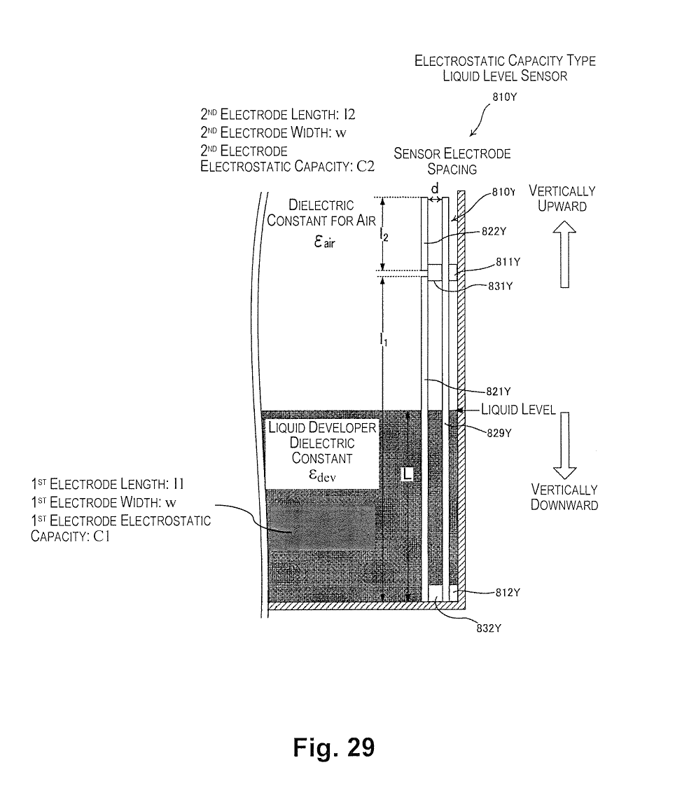

An eighth embodiment of the invention is described below. The eighth embodiment is different from the previous embodiments in regard to the configuration of the electrostatic capacity type liquid level sensor 810Y provided in the concentration adjustment tank 400Y. The following description will thus focus on the electrostatic capacity type liquid level sensor 810Y pertaining to the eighth embodiment. FIG. 29 is a diagram illustrating the electrostatic capacity type liquid level sensor 810Y of the developing device pertaining to the eighth embodiment of the invention.

In the eighth embodiment, a shared electrode 829Y is provided opposite a second electrode 822Y in the vertically upward direction of the shared electrode 829Y, and the shared electrode 829Y and the second electrode 822Y constitute a second capacitor. In addition, the shared electrode 829Y is provided opposite a first electrode 821Y in the vertically downward direction of the shared electrode 829Y, and the shared electrode 829Y and the first electrode 821Y constitute a first capacitor. In addition, the length of the opposing parts of the first electrode 821Y and the third electrode 823Y is l₁ and the widths are w, and the length of the opposing parts of the second electrode 822Y and the fourth electrode 824Y is l₂, and the widths are w.

In the eighth embodiment, the first capacitor C1 that is constituted by the first electrode 821Y and the third electrode 823Y is used for measuring the liquid level, and the second capacitor C2 that is constituted by the second electrode 822Y and the shared electrode 829Y is used as a cable electrostatic capacity reference. The term “cable” (not shown in the drawings) refers to a cable that conductively connects the first electrode 821Y, the second electrode 822Y, the shared electrode 829Y, and an electrostatic capacity measurement circuit. This type of cable has a floating capacity and has a shape that supplements the electrostatic capacity of the capacitor that is formed between the electrodes. The eighth embodiment is a computation example whereby error of this type due to cable electrostatic capacity can be eliminated. The eighth embodiment can be suitably used in cases where there is little change in developer concentration, and error is governed by the change in cable electrostatic capacity occurring in conjunction changes in temperature.

The electrostatic capacity that is measured by the electrostatic capacity measurement circuit of the capacitor C1 can be determined using formula (22) below.

$$\begin{matrix}[ Numerical formula 22 ] & \\ {C}_{1} = {ɛ}_{dev} \frac{wL}{d} + {ɛ}_{air} \frac{w ( {l}_{1} - L )}{d} + {C}_{cable} & ( 22 )\end{matrix}$$

Where C_{cable} is the cable electrostatic capacity.

In addition, the electrostatic capacity of the capacitor C2 measured by the electrostatic capacity measurement circuit can be determined as shown in formula (23) below.

$$\begin{matrix}[ Numerical formula 23 ] & \\ {C}_{2} = {ɛ}_{air} \frac{{wl}_{2}}{d} + {C}_{cable} & ( 23 )\end{matrix}$$

Formula (24) which is a computational formula for the liquid level L can be obtained from formula (22) and formula (23).

$$\begin{matrix}[ Numerical formula 24 ] & \\ L = \frac{d}{w ( {ɛ}_{dev} - {ɛ}_{air} )} \{ ( {C}_{1} - {C}_{2} ) - \frac{{ɛ}_{air} w ( {l}_{1} - {l}_{2} )}{d} \} = \frac{d}{w ( {ɛ}_{dev} - {ɛ}_{air} )} ( Δ {C}_{1} - {C}_{cable} ) \\ Where , & ( 24 ) \\ [ Numerical formula 25 ] & \\ {C}_{cable} = {C}_{2} - {ɛ}_{air} \frac{{wl}_{2}}{d} & ( 25 ) \\ [ Numerical formula 26 ] & \\ Δ {C}_{1} = {C}_{1} - \frac{{ɛ}_{air} {wl}_{1}}{d} = {C}_{1} - {C}_{0} & ( 26 ) \\ [ Numerical formula 27 ] & \\ {C}_{0} = \frac{{ɛ}_{air} {wl}_{1}}{d} & ( 27 )\end{matrix}$$

C0 is the electrostatic capacity when the entire length of the first electrode 821Y is in air and does not include the cable electrostatic capacity. In addition, ΔC1 is the difference of the electrostatic capacity C1 with respect to C0 used as a reference.

C_{cable} is obtained from measurement by the second electrode 822Y. When substituted into formula (24), the liquid level L can be accurately computed from the electrostatic capacity measured value C1 of the first electrode 821Y.

As described above, if the cable electrostatic capacity varies a large error occurs when the liquid level L is determined only from the electrostatic capacity measured value from the first electrode 821Y. However, in this embodiment, the liquid level L can be accurately computed by using the second electrode 822Y as a reference electrode and computing the cable electrostatic capacity C_{cable}. By ascertaining the liquid level of the accommodating part 401Y in accordance with the developing device and image forming device of the invention of this type, it is possible to replenish an appropriate amount so that the developer reaches the target concentration, thereby preventing degradation of image quality.

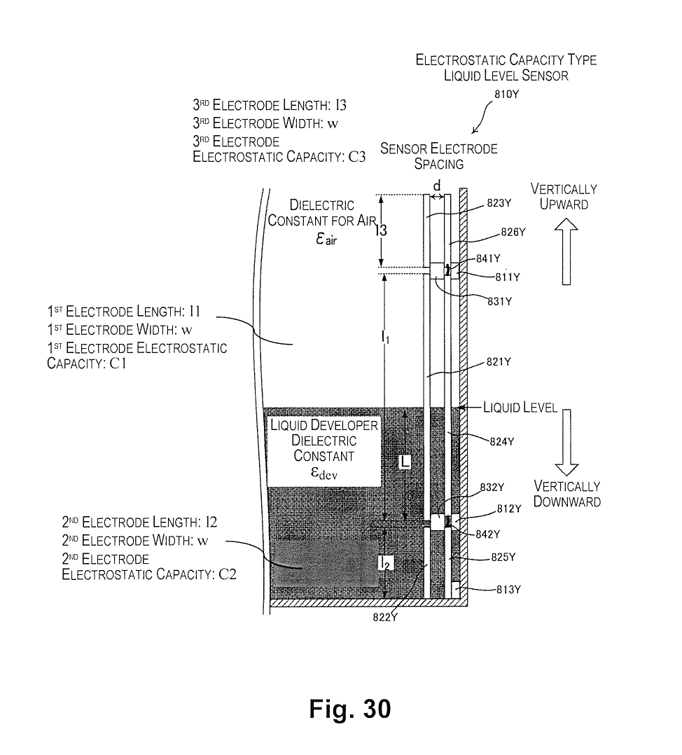

A ninth embodiment of the invention is described below. The ninth embodiment is different from the previous embodiments in regard to the configuration of the electrostatic capacity type liquid level sensor 810Y provided in the concentration adjustment tank 400Y. The following description will thus focus on the electrostatic capacity type liquid level sensor 810Y pertaining to the ninth embodiment. FIG. 30 is a diagram illustrating the electrostatic capacity type liquid level sensor 810Y of the developing device pertaining to the ninth embodiment of the invention.

In the ninth embodiment, a third electrode 823Y is provided opposite a sixth electrode 826Y in a vertically upwards part of the concentration adjustment tank 400Y, forming a third capacitor. In addition, a second electrode 822Y is provided opposite a fifth electrode 825Y in a vertically downwards part of the concentration adjustment tank 400Y, forming a second capacitor. In the middle of the vertically upwards part and the vertically downwards part of the concentration adjustment tank 400Y, a first capacitor is formed from a first electrode 821Y that is provided opposite a fourth electrode 824Y.

In addition, the lengths of the first electrode 821Y and the fourth electrode 824Y that constitute the first capacitor are L₁, and the widths are w, the lengths of the second electrode 822Y and the fifth electrode 825Y that constitute the second capacitor are l₂ and the widths are w, and the lengths of the third electrode 823Y and the sixth electrode 826Y that constitute the third capacitor are l₃, and the widths are 2. In addition, the sixth electrode 826Y and the fourth electrode 824Y are conductively connected by a ground connection 841Y, and the fourth electrode 824Y and the fifth electrode 825Y are conductively connected by a ground connection 842Y.

In the ninth embodiment, the first capacitor C1 that is constituted by the first electrode 821Y and the fourth electrode 824Y is used for measuring the liquid level, the second capacitor C2 that is constituted by the second electrode 822Y and the fifth electrode 825Y is used for measuring the concentration reference, and the third capacitor C3 that is constituted by the third electrode 823Y and the sixth electrode 826Y is used for measuring the cable electrostatic capacity reference. Liquid level computation thus can be carried out by eliminating the two errors resulting from variation in the dielectric constant ∈_{dev} of the developer and variation in the cable electrostatic capacity. The ninth embodiment is suitable in cases where there is significant error due to change in developer concentration and error due to change in cable electrostatic capacity.

The cable electrostatic capacity C_{cable} can be obtained from the measured value of the third capacitor C3 using formula (28).

$$\begin{matrix}[ Numerical formula 28 ] & \\ {C}_{cable} = {C}_{3} - {ɛ}_{air} \frac{{wl}_{3}}{d} & ( 28 )\end{matrix}$$

In addition, the dielectric constant ∈_{dev} of the developer can be obtained from the measured value of the second capacitor C2 using formula (29).

$$\begin{matrix}[ Numerical formula 29 ] & \\ {ɛ}_{dev} = \frac{d}{{wl}_{2}} \{ {C}_{2} - ( {C}_{3} - {ɛ}_{air} \frac{{wl}_{3}}{d} ) \} = \frac{d}{{wl}_{2}} ( {C}_{2} - {C}_{cable} ) & ( 29 )\end{matrix}$$

From the measured value of the first capacitor C1 along with formulas (28) and (29), the liquid level L of the developer can be obtained using formula (30).

$$\begin{matrix}[ Numerical formula 30 ] & \\ L = \frac{d}{w ( {ɛ}_{dev} - {ɛ}_{air} )} \{ ( {C}_{1} - \frac{{ɛ}_{air} {wl}_{1}}{d} ) - ( {C}_{3} - \frac{{ɛ}_{air} {wl}_{3}}{d} ) \} = \frac{d}{w ( {ɛ}_{dev} - {ɛ}_{air} )} \{ ( {C}_{1} - \frac{{ɛ}_{air} {wl}_{1}}{d} ) - {C}_{cable} \} & ( 30 )\end{matrix}$$

where:

$$\begin{matrix}[ Numerical formula 31 ] & \\ Δ {C}_{1} = {C}_{1} - \frac{{ɛ}_{air} {wl}_{1}}{d} = {C}_{1} - {C}_{0} & ( 31 ) \\ [ Numerical formula 32 ] & \\ {C}_{0} = \frac{{ɛ}_{air} {wl}_{1}}{d} & ( 32 )\end{matrix}$$

C0 is the electrostatic capacity when the entire length of the first capacitor is in air and does not include the cable electrostatic capacity. In addition, ΔC1 is the difference of the electrostatic capacity C1 with respect to C0 used as a reference.

C_{cable} is obtained by measurement of the third capacitor, and ∈_{dev} is obtained by measurement of the second capacitor. By substituting these values into formula (30), it is possible to accurately compute the liquid level L from the electrostatic capacitor measured value C1 of the first capacitor.

As described above, if the developer concentration or cable electrostatic capacity varies, a large error occurs when the liquid level L is determined only from the electrostatic capacity measured value from the first capacitor. However, in this embodiment, by using the second capacitor and third capacitor as reference electrodes, the cable electrostatic capacity C_{cable} can be computed, and the liquid level L can be accurately computed.

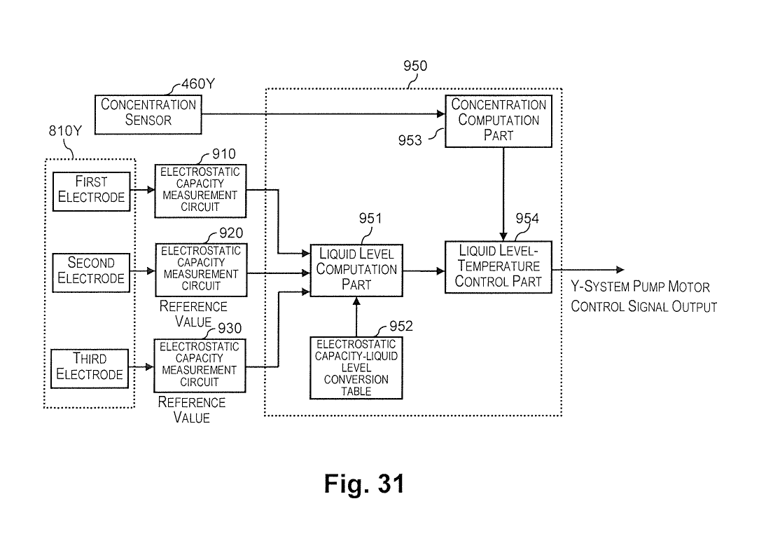

The following describes a control example for the exposure device 30Y having the configuration described above. FIG. 31 is diagram showing a block configuration related to computation of the liquid level of the developer in the concentration adjustment tank 400Y in a ninth embodiment. In FIG. 31, the microcomputer 950 is a general-purpose information processing device including a CPU, ROM that stores the programs to be executed by the CPU, RAM which is the work area for the CPU, and the like. Various processing parts and storage parts such as a liquid level computation part 951, an electrostatic capacity-liquid level computation table 952, a concentration computation part 953, a liquid level-concentration controller 954, and the like can be understood as being provided virtually on the microcomputer 650.

The input from the first electrode 821Y, the second electrode 822Y, and the third electrode 823Y that constitute the electrostatic capacity type liquid level sensor 810Y are input into an electrostatic capacity measurement circuit 910, an electrostatic capacity measurement circuit 920, and an electrostatic capacity measurement circuit 930, and respective electrostatic capacity data sets are produced. The electrostatic capacity measurement circuit, for example, can be a circuit having a configuration whereby a known current is supplied to the electrode for a prescribed time period to charge the capacitor, and the voltage between the electrodes is then measured, thereby acquiring the electrostatic capacity.

Electrostatic capacity data that has been detected by the first capacitor, electrostatic capacity data (developer dielectric constant reference) that has been detected by the second capacitor, and electrostatic capacity data (cable electrostatic capacity reference) that has been detected by the third capacitor are input respectively from the electrostatic capacity measurement circuit 910, the electrostatic capacity measurement circuit 920, and the electrostatic capacity measurement circuit 930 into the microcomputer 950. In addition, concentration data is input from the concentration sensor 460Y into the microcomputer 950.

At the liquid level computation part 951 in the microcomputer 950, the electrostatic capacity-liquid level computation table 952 is referenced, and the liquid level is computed based on the electrostatic capacity data that has been input from electrostatic capacity measurement circuit 910, the electrostatic capacity measurement circuit 920, and the electrostatic capacity measurement circuit 930. The electrostatic capacity-liquid level computation table 952 is a table in which three sets of electrostatic capacity data and liquid level data combinations are stored. This table is constructed based on formulas (28) to (32) described previously.

The data from the concentration sensor 460Y is processed by the concentration computation part 953 and is input into the liquid level-concentration controller 954. The concentration sensor 460Y and the concentration detection part 953 are described, for example, in JP (Kokai) 2009-75558, and the method for detecting the concentration can employ, for example, a transmissive concentration sensor.

The liquid level data that is output by the liquid level computation part 951 and the concentration data that is output by the concentration computation part 953 are input into the liquid level-concentration controller 954.

The liquid level-concentration controller 954 is a controller that carries out simultaneous control of the liquid level and concentration in order to maintain a constant liquid level and concentration in the concentration adjustment tank 400Y based on the liquid level data that has been computed by the liquid level computation part 951 and the concentration data that has been computed by the concentration computation part 953. The high-concentration developer and carrier replenishment amounts are computed in order to simultaneously maintain a constant liquid level and concentration. In addition, based on the computed values, a drive signal is output to the motors of the respective pumps so that liquid is transferred to the concentration adjustment tank 400Y from the high-concentration developer tank 510Y, the carrier liquid tank 520Y, and the buffer tank 530Y. As a result, correct replenishment is performed in accordance with the liquid level and concentration, and the liquid level and concentration are maintained.

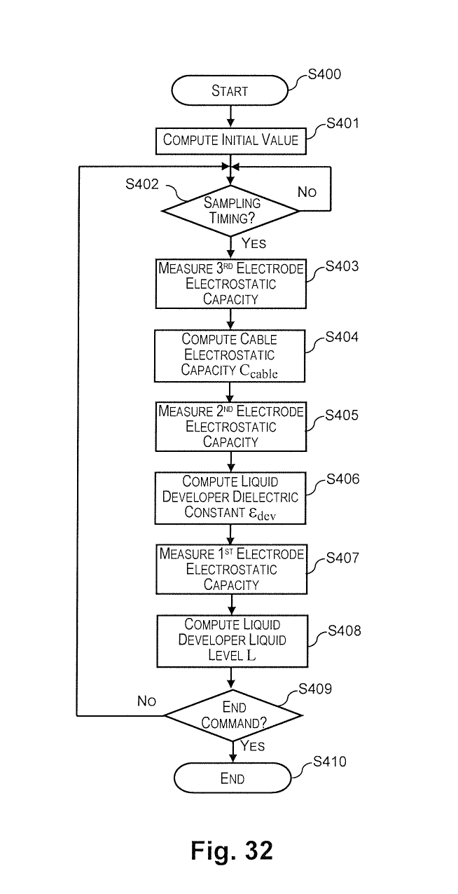

FIG. 32 is a flow chart for computing the liquid level of the developer in the concentration adjustment tank of the ninth embodiment. When processing is initiated in step S400, initial value computation is carried out in step S401. In initial value computation, the electrostatic capacity initial value C0 is computed based on formulas (31) and (32) when the entire length of the first electrode 821Y is in air.

In step 402, it is determined whether there is sampling timing, and the routine proceeds to step S403 when this determination is YES.

In step S403, electrostatic capacity measurement is carried out by the third electrode 823Y, and in the next step S404, the cable electrostatic capacity C_{cable} is computed based on this measurement.

In step S405, electrostatic capacity measurement is carried out by the second electrode 822Y, and, in step S406, the developer dielectric constant ∈_{dev} is computed based on this measurement. In addition, in step S407, electrostatic capacity measurement is carried out by the first electrode 821Y, and, in step S408, the developer liquid level L is then computed referencing the electrostatic capacity-liquid level computation table 952.

In step S409, it is determined whether or not there is a stop command from an upper-level device. If this determination is NO, then the routine loops back to step S402, whereas the routine proceeds to step S410 and processing stops if the determination is YES.

With the developing device and image forming device of the invention, the liquid level of the developer is determined from the first electrostatic capacity that is obtained from the first electrode 821Y using the second electrostatic capacity detected by the second electrode 822Y as a reference value for the developer dielectric constant ∈_{dev} and using the third electrostatic capacity detected by the third electrode 823Y as a reference value for the cable electrostatic capacitor C_{cable}. The liquid level can thus be determined while taking into account changes in the cable electrostatic capacity and changes in the dielectric constant of the developer due to temperature or concentration. By ascertaining the liquid level of the accommodating part 401Y in accordance with the developing device and image forming device of the invention, it is possible to replenish an appropriate amount so that the developer reaches the target concentration, thereby preventing degradation of image quality.

What is claimed is:

1. An image forming device, comprising:
a latent image support on which a latent image is formed;
an exposure part for exposing the latent image support to light and forming the latent image on the latent image support;
a toner concentration adjustment part for adjusting the toner concentration of the developer, the toner concentration adjustment part having an accommodating part for accommodating a developer including a toner and a carrier, and an electrostatic capacity detector for detecting electrostatic capacity, the electrostatic capacity detector having a first electrode provided to the accommodating part, a second electrode provided to the accommodating part, and a counter electrode opposite the first electrode and the second electrode interposed by the developer;
a developer supply part for supplying, to the accommodating part, developer having a higher toner concentration than the toner concentration of the developer adjusted by the toner concentration adjustment part;
a carrier supply part for supplying a carrier to the accommodating part;
a developing part having a developer container into which is supplied developer whose toner concentration has been adjusted by the toner concentration adjustment part, and a developer support for supporting the developer accommodated in the developer container and developing the latent image on the latent image support; and
a controller for controlling an amount of developer supplied by the developer supply part and an amount of carrier supplied by the carrier supply part, based on a first electrostatic capacity detected by the first electrode and the counter electrode of the electrostatic capacity detector and a second electrostatic capacity detected by the second electrode and the counter electrode.

2. The image forming device according to claim 1, wherein
the controller stops supply of the developer from the accommodating part to the developer container based on the first electrostatic capacity and the second electrostatic capacity.

3. The image forming device according to claim 2, further comprising
a computation part for computing the liquid level of the developer produced in the accommodating part based on the first electrostatic capacity and the second electrostatic capacity.

4. An image forming device, comprising:
a latent image support on which a latent image is formed;
an exposure part for exposing the latent image support to light and forming the latent image on the latent image support;
a developing part that has a developing container for accommodating a developer including a toner and a carrier, and a developer support for supporting the developer accommodated in the developer container and developing the latent image; and
a developer reservoir having an accommodating part for accommodating a developer supplied to the developing part, and an electrostatic capacity detector for detecting electrostatic capacity, the electrostatic capacity detector having a first electrode provided in the accommodating part, a second electrode provided to the accommodating part opposite the first electrode and interposed by the developer, and a third electrode provided to the accommodating part opposite the first electrode and interposed by the developer.

5. The image forming device according to claim 4, wherein
the third electrode is disposed vertically below the second electrode.

6. The image forming device according to claim 5, further comprising
a developer supply tube for supplying developer from the accommodating part to the developing container, the developer supply tube having an inlet within the accommodating part; wherein
the third electrode is disposed vertically below the inlet of the developer supply tube.

7. The image forming device according to claim 6, wherein
the electrostatic capacity detector has a fourth electrode that is provided to the accommodating part opposite the first electrode, interposed by the developer.

8. The image forming device according to claim 7, wherein
the accommodating part further includes a discharge opening for discharging developer, and
the fourth electrode is disposed vertically above the discharge opening of the accommodating part.

9. An image forming device, comprising:
a latent image support on which a latent image is formed;
an exposure part for exposing the latent image support to light and forming the latent image on the latent image support;
a developer reservoir for storing developer, the developer reservoir having an accommodating part for accommodating a developer including a toner and a carrier, and an electrostatic capacity detector for detecting electrostatic capacity, the electrostatic capacity detector having a first electrode provided to the accommodating part, and a second electrode provided to the accommodating part;
a developing part having a developer container into which is supplied developer accommodated in the accommodating part of the developer reservoir, and a developer support for supporting the developer accommodated in the developer container and developing the latent image that has been formed on the latent image support; and
a computation part for computing a liquid level of the developer in the accommodating part based on a first electrostatic capacity detected between the first electrode and the counter electrode and a second electrostatic capacity detected between the second electrode and the counter electrode.

10. The image forming device according to claim 9, wherein
the electrostatic capacity detector has a counter electrode that is opposite the first electrode and the second electrode.

11. The image forming device according to claim 10, wherein
the second electrode is disposed vertically below the first electrode and opposite the counter electrode, interposed by the developer.

12. The image forming device according to claim 10, wherein
the first electrode is opposite the counter electrode and interposed by the developer, and the second electrode is disposed vertically above the first electrode and opposite the counter electrode, without being interposed by the developer.

13. The image forming device according to claim 12, further comprising
a cable for conductively connecting the first electrode and a capacity measurement circuit, wherein the computation part computes the electrostatic capacity of the cable using the first electrostatic capacity detected between the first electrode and the counter electrode.
